(19) United States
(12) Patent Application Publication
(10) Pub. No.: US 2020/0401700 A1
(43) Pub. Date: Dec. 24, 2020

(54) INFRASTRUCTURE FOR SECURING AND/OR MANAGING IOT-TYPE DEVICES

(71) Applicant: ARM IP Limited, Cambridge (GB)

(72) Inventors: Brendan James Moran, Histon (GB); Tony John Ibbs, Cambridge (GB); Georgios Psimenos, Cambridge (GB)

(21) Appl. No.: 16/691,476

(22) Filed: Nov. 21, 2019

(30) Foreign Application Priority Data
Jun. 19, 2019 (EP) 19386033.5

(51) Int. Cl. G06F 21/57; G06F 21/74; G06F 8/65

(52) U.S. Cl. CPC G06F 21/572; G06F 8/65; G06F 21/74; G06F 21/575

(57) ABSTRACT

Briefly, example methods, apparatuses, and/or articles of manufacture are disclosed that may be implemented, in whole or in part, using one or more computing devices to facilitate and/or support one or more operations and/or techniques for securing and/or managing IoT-type devices, such as implemented, at least in part, via one or more behavioral electronic documents and/or one or more electronic communications.

### CROSS-REFERENCE TO RELATED APPLICATIONS

This application claims the benefit of and priority to European Patent Application No. EP19386033.5, entitled “INFRASTRUCTURE FOR SECURING AND/OR MANAGING IOT-TYPE DEVICES,” filed on Jun. 19, 2019, which is assigned to the assignee hereof and which is expressly incorporated herein by reference in its entirety.

### BACKGROUND

### 1. Field

The present disclosure relates generally to Internet of Things (IoT)-type devices and, more particularly, to infrastructure for securing and/or managing IoT-type devices, such as via one or more behavioral electronic documents, for example.

### 2. Information

The Internet is widespread. The World Wide Web or simply the Web, provided by the Internet, is growing rapidly, at least in part, from the large amount of content being added seemingly on a daily basis. A wide variety of content in the form of stored signals, such as, for example, text files, images, audio files, video files, web pages, measurements of physical phenomena, or the like is continually being acquired, identified, located, retrieved, collected, stored, communicated, etc. Increasingly, content is being acquired, collected, communicated, etc. by a number of embedded computing devices leveraging existing Internet or like infrastructure as part of the so-called “Internet of Things” or IoT, such as via a variety of protocols, domains, and/or applications. The IoT is typically a system of interconnected and/or internetworked physical computing devices capable of being identified, such as uniquely via an assigned Internet Protocol (IP) address, for example, and in which computing is embedded into hardware so as to facilitate and/or support devices' ability to acquire, collect, and/or transmit content over one or more communications networks. IoT devices may comprise a wide variety of embedded devices, such as, for example, automobile sensors, biochip transponders, heart monitoring implants, thermostats, kitchen appliances, locks or like fastening devices, solar panel arrays, home gateways, controllers, or the like.

In some instances, the nature of IoT devices, such as by virtue of having an embedded computing and/or communication capability, for example, which may include a capability to automatically access the Internet, may make the IoT devices vulnerable. As such, at times, IoT devices may become compromised, such as if used without appropriate and/or timely maintenance, firmware updates, or the like. For example, an IoT device, such as a field surveillance or security camera may remain successfully deployed for many years, provided that firmware for the camera is up to date. As such, firmware updates may play an important or even critical part in a lifetime of the camera, particularly if the camera is deployed in a remote or inaccessible area, where manual intervention is cost prohibitive, difficult, or the like. If firmware for the camera is outdated, however, the camera may pose a risk in reliability, perhaps because of compromised security, perhaps because its operational parameters need to compensate for new environmental factors and/or aging of the device (e.g., higher resolution, color display, memory footprint, etc.), or some other aspects not fully anticipated at the time the camera was originally designed and/or deployed. As such, for certain electronic devices, such as IoT devices, which may include resource constrained IoT devices, for example, lack of timely maintenance, updates, etc. may endanger associated IoT infrastructure and/or those dependent upon their use.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram illustrating features associated with an implementation of an example operating environment for infrastructure for securing and/or managing IoT-type devices.

FIGS. 2-9 are examples of an implementation of functionalities of an electronic behavioral document.

FIGS. 10-12 are flow diagrams of an implementation of example use cases or scenarios for infrastructure for securing and/or managing IoT-type devices.

FIG. 13 is a flow diagram illustrating an implementation of example asynchronous processing.

FIG. 14 is a flow diagram illustrating an implementation of example dependencies processing.

FIG. 15 is a flow diagram illustrating an implementation of example conditional processing.

FIG. 16 is a schematic diagram illustrating an implementation of an example computing environment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

Some example methods, apparatuses, and/or articles of manufacture are disclosed herein that may be used, in whole or in part, to facilitate and/or support one or more operations and/or techniques for infrastructure for securing and/or managing IoT-type devices, such as implemented in connection with one or more computing and/or communication networks and/or protocols (e.g., network protocols) discussed herein, for example. As will be seen, in some instances, one or more operations and/or techniques for infrastructure for securing and/or managing IoT-type devices may be implemented, at least in part, via one or more behavioral electronic documents, such as communicated and/or otherwise accessible to the IoT-type devices. In this context, a “behavioral” electronic document refers to an electronic document comprising electronic content that defines and/or prescribes a behavior of an electronic device, such as an IoT-type device, for example. To illustrate, in the context of a firmware update, as one non-limiting example, a behavioral electronic document may describe what the device should do, for example, rather that what the firmware update is, such as in a conventional descriptive electronic document. It should be noted that “behavior” and “behaviour” or like terms or derivatives (e.g., “behavioral,” “behavioural,” etc.) may be used interchangeably herein. The term “electronic document” refers to one or more digital signals, such as communicated and/or stored signals, for example, representing any electronic content including a binary, source code, text, image, audio, video file, or the like. Particular examples of IoT-type devices, behavioral electronic documents, computing and/or communication networks and/or protocols, etc. will be discussed in greater detail below.

“Electronic content,” as the term used herein, should be interpreted broadly and refers to signals, such signal packets, for example, and/or states, such as physical states on a memory device, for example, but otherwise is employed in a manner irrespective of format, such as any expression, representation, realization, and/or communication, for example. Content may comprise, for example, any information, knowledge, and/or experience, such as, again, in the form of signals and/or states, physical or otherwise. In this context, “electronic” or “on-line” content refers to content in a form that although not necessarily capable of being perceived by a human, (e.g., via human senses, etc.) may nonetheless be transformed into a form capable of being so perceived, such as visually, haptically, and/or audibly, for example. Non-limiting examples may include text, audio, images, video, environmental parameters, combinations, or the like. Thus, content may be stored and/or transmitted electronically, such as before or after being perceived by human senses. In general, it may be understood that electronic content may be intended to be referenced in a particular discussion, although in the particular context, the term “content” may be employed for ease of discussion. Specific examples of content may include, for example, computer code, metadata, message, text, audio file, video file, data file, web page, or the like. Claimed subject matter is not intended to be limited to these particular examples, of course.

As alluded to previously, at times, securing and/or maintaining IoT-type devices within a network may present a number of challenges, which may be due, at least in part, to the devices' inherent ability to automatically access and/or communicate on a network, such as the Internet, as one possible example. Typically, although not necessarily, in contrast to more advanced computing platforms with more sophisticated anti-virus and/or malware defenses, many IoT-type devices may comprise, for example, resource constrained embedded devices that utilize hardware and/or software solutions lacking computing or processing power to run a sufficient security software, implement secure firmware update, secure boot, or the like. As such, in some instances, IoT-type devices may be vulnerable to, as one example, brute-force attacks and/or other nefarious on-line attacks, log-in exploits, etc. that may give attackers access to and/or control of the devices and, as a consequence, compromise associated services, systems, networks, or the like.

In some instances, to address these or like challenges, one or more firmware update approaches, such as, for example, to fix one or more security vulnerabilities, update configuration settings, add new functionality, or the like may be implemented. For example, fully descriptive, partially descriptive, partially imperative, and/or fully imperative updates may, for example, be employed herein, in whole or in part. Typically, fully descriptive updates may be implemented, in whole or in part, via an electronic document, such as communicated (e.g., via a payload, etc.) or otherwise accessible to an IoT-type device, for example, that describes a piece of information (e.g., firmware, etc.) for that particular IoT-type device. Partially descriptive and/or partially imperative updates may include, for example, an electronic document comprising one or more packaged computer files, such as those used in Linux (e.g., in .rpm, .deb, etc. file format), as one possible example, which may typically contain one or more computer scripts. Fully imperative updates may include an electronic document comprising a computer script or executable code, such as an installer, for example. At times, these or like approaches, however, may be operationally expensive, may be dependent upon a specific IoT-type device, threat and/or security objective, may involve solutions requiring a relatively large, complex, and/or dedicated infrastructure, or the like.

For example, electronic documents comprising fully descriptive updates may require complex structure so as to define a number of complex and/or different use cases. Here, an associated description may typically comprise a larger number of optional fields, for example, and describing capabilities of an IoT-type device may be rather difficult and/or operationally expensive. At times, this may create a situation in which an IoT-type device may need to construct an assumed behavior in accordance with a provided specification, such as handling a larger number of edge cases, for example, which may introduce significant complexity. In some instances, capabilities of an IoT-type device may also be difficult to specify because they may imply behaviors, rather than information, but a descriptive electronic document, by definition, specifies information rather than these capabilities. As such, capabilities (e.g., supported behaviors, etc.) of an IoT-type device may need to be interpreted into allowable combinations, such as in accordance with provided information (e.g., via a payload, etc.), for example. As a result, this may create a situation where a behavior of an IoT-type device may be imprecisely specified by an electronic document that the device may utilize to perform secure firmware update, boot, or the like.

Continuing with the above discussion, partially descriptive and/or partially imperative updates may also have drawbacks, such as via associated computer scripts, for example. This may partially be due to script size, for example, but may also be due, at least in part, to testing. For example, complexity of computer scripts may mean that extensive testing may need to be done on a new package. Updates utilizing packaged files (e.g., in .rpm, .deb, etc. file format) may also suffer from having a larger number of predefined operations and/or predefined metadata, which may make it more complex to code and/or implement for operation on a specific processor architecture (e.g., an RPM processor, etc.). With respect to fully imperative updates, these are effectively installer binaries, for example, and may execute arbitrary code. A behavior of an installer binary, however, may not be known in advance. In addition, because these binaries are executable images, they are typically not compact, even if they use shared libraries, for example. In addition, here, testing may also be burdensome. Also, since a particular IoT-type device may require a different subset of content, distributing firmware in a multi-party environment may also be challenging. For example, some content of an electronic document may not be accessible to and/or processable by a number of IoT-type devices, multiple signatures may be required or otherwise useful from IoT-type devices with different authorities, or the like. An “authority” or “update authority” typically refers to an owner of a cryptographic key used to sign updates and trusted by IoT-type devices. Accordingly, it may be desirable to develop one or more methods, systems, and/or apparatuses that may implement one or more operations and/or techniques for infrastructure for securing and/or managing IoT-type devices, such as via one or more behavioral electronic documents suitably encoded to facilitate and/or support a more flexible behavior to IoT-type devices, which may include resource constrained devices, for example, while allowing more powerful IoT-type devices to use their full or more advanced update capabilities.

Thus, as will be described in greater detail below, in an implementation, a behavior of an IoT-type device may be specified, such as via encoding such a behavior for the IoT-type device to implement, for example, instead of just presenting information used to determine that behavior. As also discussed below, in some instances, a behavior of an IoT-type device may be encoded in a behavioral electronic document, such as a behavioral manifest, for example, that may be communicated (e.g., via a push technology, etc.) and/or otherwise accessible (e.g., via a pull technology, etc.) to the IoT-type device. Typically, “manifest” refers to one or more electronic documents comprising metadata descriptive of one or more associated computer files that are part of a set or coherent unit. For example, a manifest may comprise metadata descriptive of one or more associated payloads, resources, processors for transforming resources into payloads, firmware, document version, number, or the like. A particular example of a manifest that may be used, in whole or in part, to facilitate and/or support one or more operations and/or techniques for infrastructure for securing and/or managing IoT-type devices, such as a behavioral manifest, for example, will be discussed in greater detail below. As used herein, “firmware,” “firmware image,” or simply “image” refers to electronic content, such a computer file, for example, comprising complete software of a computing device (e.g., an IoT-type device, etc.) or a subset of such software. For example, in some instances, a firmware image may comprise a binary file and may include multiple images, such as if a computing device contains more than one microcontroller.

As also discussed below, unlike a conventional scripting language or byte code, a behavioral electronic document, such as a behavioral manifest, for example, may comprise a very high-level language encoded into a relatively small space, but capable of sufficiently defining operations for an IoT-type device to perform, at times, in a particular order, such as during update and/or secure boot of a firmware image. More specifically, unlike a conventional scripting language or byte code, a language of a behavioral manifest may specify a behavior in a linearized form, such as, for example, without reverse branches. As will be seen, in some instances, a behavioral manifest may comprise, for example, a signed electronic document describing one or more operations to be performed in a constrained environment, with one or more sequences of dependent operations governed or guarded by one or more preconditions that define results of a previous task sequence. In addition, at times, two or more different processes may also be encoded in one behavioral document, for example, and may share common parts, as will also be seen. Conditional processing may also be supported, for example, and/or parallel and out-of-order processing may be performed, such as by a number of sufficiently capable IoT-type devices. As such, a processing model may, for example, be advantageously changed from a conventional information model, such as discussed above (e.g., loading a manifest, interpreting associated content, then performing some actions, etc.), into a more effective and/or more efficient behavioral model in which an IoT-type device performs operations specified in a behavioral manifest, at times, in order. In some instances, this may allow for encoding a behavioral manifest in a way that may match precisely with what a parser expects, which may also be beneficial. It may also make a less flexible computer code or process, such as a bootloader, as one example, more or suitably flexible, for example, since manifest's execution operations may define part of a behavior of an IoT-type device, as will also be seen. Again, particular examples of a behavioral electronic document, such as a behavioral manifest, for example, and its structure, processing operations, commands, parameters, etc. will be discussed in greater detail below.

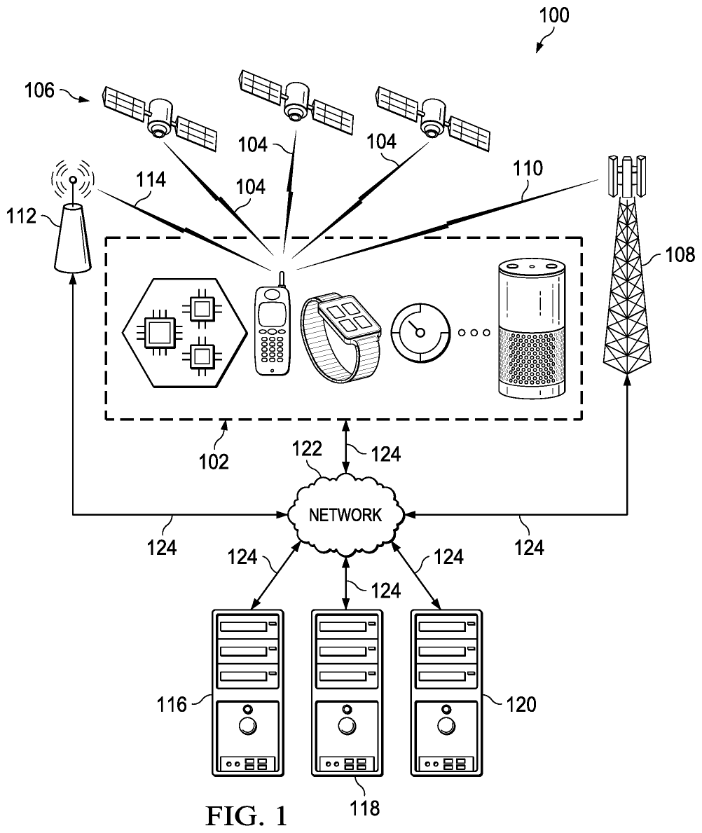

FIG. 1 is a schematic diagram illustrating features associated with an implementation of an example operating environment 100 capable of facilitating and/or supporting one or more operations and/or techniques for infrastructure for securing and/or managing IoT-type devices, illustrated generally herein at 102. In this context, “IoT-type devices” refer to one or more electronic or computing devices capable of leveraging existing Internet or like infrastructure as part of the so-called “Internet of Things” or IoT, such as via a variety of applicable protocols, domains, applications, etc. As was indicated, the IoT is typically a system of interconnected and/or internetworked physical devices in which computing is embedded into hardware so as to facilitate and/or support devices' ability to acquire, collect, and/or communicate content over one or more communications networks, for example, at times, without human participation and/or interaction. IoT-type devices may include a wide variety of stationary and/or mobile devices, such as, for example, automobile sensors, biochip transponders, heart monitoring implants, kitchen appliances, locks or like fastening devices, solar panel arrays, home gateways, smart gauges, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio or video devices, personal navigation devices, or the like. Typically, in this context, a “mobile device” refers to an electronic or computing device that may from time to time have a position or location that changes, and a stationary device refers to a device that may have a position or location that generally does not change. In some instances, IoT-type devices may be capable of being identified, such as uniquely, via an assigned Internet Protocol (IP) address, as one particular example, and/or having the ability to communicate, such as receive and/or transmit electronic content, for example, over one or more wired and/or wireless communications networks.

It should be appreciated that operating environment 100 is described herein as a non-limiting example that may be implemented, in whole or in part, in the context of various wired or wireless communications networks, or any suitable portion and/or combination of such networks. For example, these or like networks may include one or more public networks (e.g., the Internet, the World Wide Web), private networks (e.g., intranets), wireless wide area networks (WWAN), wireless local area networks (WLAN, etc.), wireless personal area networks (WPAN), telephone networks, cable television networks, Internet access networks, fiber-optic communication networks, waveguide communication networks, or the like. It should also be noted that claimed subject matter is not limited to a particular network and/or operating environment. For example, in some instances, an optical network may be used herein, in whole or in part, such as separately and/or in any suitable combination with one or more networks discussed herein. Thus, depending on an implementation, one or more operations and/or techniques for infrastructure for securing and/or managing IoT-type devices may be performed, at least in part, in an indoor environment, an outdoor environment, or any combination thereof.

Thus, as illustrated, in an implementation, one or more IoT-type devices 102 may, for example, receive or acquire satellite positioning system (SPS) signals 104 from SPS satellites 106. In some instances, SPS satellites 106 may be from a single global navigation satellite system (GNSS), such as the GPS or Galileo satellite systems, for example. In other instances, SPS satellites 106 may be from multiple GNSS such as, but not limited to, GPS, Galileo, Glonass, or Beidou (Compass) satellite systems. In certain implementations, SPS satellites 106 may be from any one several regional navigation satellite systems (RNSS) such as, for example, WAAS, EGNOS, QZSS, just to name a few examples.

At times, one or more IoT-type devices 102 may, for example, transmit wireless signals to, or receive wireless signals from, a suitable wireless communication network. In one example, one or more IoT-type devices 102 may communicate with a cellular communication network, such as by transmitting wireless signals to, or receiving wireless signals from, one or more wireless transmitters capable of transmitting and/or receiving wireless signals, such as a base station transceiver 108 over a wireless communication link 110, for example. Similarly, one or more IoT-type devices 102 may transmit wireless signals to, or receive wireless signals from a local transceiver 112 over a wireless communication link 114. Base station transceiver 108, local transceiver 112, etc. may be of the same or similar type, for example, or may represent different types of devices, such as access points, radio beacons, cellular base stations, femtocells, an access transceiver device, or the like, depending on an implementation. Similarly, local transceiver 112 may comprise, for example, a wireless transmitter and/or receiver capable of transmitting and/or receiving wireless signals. For example, at times, wireless transceiver 112 may be capable of transmitting and/or receiving wireless signals from one or more other terrestrial transmitters and/or receivers.

In a particular implementation, local transceiver 112 may, for example, be capable of communicating with one or more IoT-type devices 102 at a shorter range over wireless communication link 114 than at a range established via base station transceiver 108 over wireless communication link 110. For example, local transceiver 112 may be positioned in an indoor or like environment and may provide access to a wireless local area network (WLAN, e.g., IEEE Std. 802.11 network, etc.) or wireless personal area network (WPAN, e.g., Bluetooth® network, etc.). In another example implementation, local transceiver 112 may comprise a femtocell or picocell capable of facilitating communication via link 114 according to an applicable cellular or like wireless communication protocol. Again, it should be understood that these are merely examples of networks that may communicate with one or more IoT-type devices 102 over a wireless link, and claimed subject matter is not limited in this respect. For example, in some instances, operating environment 100 may include a larger number of base station transceivers 108, local transceivers 112, networks, terrestrial transmitters and/or receivers, etc.

In an implementation, one or more IoT-type devices 102, base station transceiver 108, local transceiver 112, etc. may, for example, communicate with one or more servers, referenced herein at 116, 118, and 120, over a network 122, such as via one or more communication links 124. Network 122 may comprise, for example, any combination of wired or wireless communication links. In a particular implementation, network 122 may comprise, for example, Internet Protocol (IP)-type infrastructure capable of facilitating or supporting communication between one or more IoT-type devices 102 and one or more servers 116, 118, 120, etc. via local transceiver 112, base station transceiver 108, directly, etc. In another implementation, network 122 may comprise, for example cellular communication network infrastructure, such as a base station controller or master switching center to facilitate and/or support mobile cellular communication with one or more IoT-type devices 102. Servers 116, 118, and/or 120 may comprise any suitable servers or combination thereof capable of facilitating or supporting one or more operations and/or techniques discussed herein. For example, servers 116, 118, and/or 120 may comprise one or more update servers, back-end servers, management servers, archive servers, location servers, positioning assistance servers, navigation servers, map servers, crowdsourcing servers, network-related servers, or the like.

In particular implementations, one or more IoT-type devices 102 may have circuitry or processing resources capable of determining a position fix or estimated location of one or more IoT-type devices 102, initial (e.g., a priori) or otherwise. For example, if satellite signals 104 are available, one or more IoT-type devices 102 may compute a position fix based, at least in part, on pseudorange measurements to four or more SPS satellites 106. Here, one or more IoT-type devices 102 may, for example, compute such pseudorange measurements based, at least in part, on pseudonoise code phase detections in signals 104 acquired from four or more SPS satellites 106. In particular implementations, one or more IoT-type devices 102 may receive from one or more servers 116, 118, or 120 positioning assistance data to aid in the acquisition of signals 104 transmitted by SPS satellites 106 including, for example, almanac, ephemeris data, Doppler search windows, just to name a few examples.

In some implementations, one or more IoT-type devices 102 may obtain a position fix by processing wireless signals received from one or more terrestrial transmitters positioned at known locations (e.g., base station transceiver 108, local transceiver 112, etc.) using any one of several techniques, such as, for example, Observed Time Difference Of Arrival (OTDOA), Advanced Forward Link Trilateration (AFLT), or the like. In these techniques, a range from one or more IoT-type devices 102 may, for example, be measured to three or more of terrestrial transmitters based, at least in part, on one or more positioning reference signals transmitted by these transmitters and received at one or more IoT-type devices 102, as was indicated. Here, servers 116, 118, or 120 may be capable of providing positioning assistance data to one or more IoT-type devices 102 including, for example, OTDOA reference transmitter data, OTDOA neighbor transmitter data, reference signal time difference search window, quality of service parameters, positioning reference signal configuration parameters, locations, identities, orientations, etc. of one or more terrestrial transmitters to facilitate and/or support one or more applicable positioning techniques (e.g., AFLT, OTDOA, etc.). At times, servers 116, 118, or 120 may include, for example, a base station almanac (BSA) indicating locations, identities, orientations, etc. of cellular base stations (e.g., base station transceiver 108, local transceiver 112, etc.) in one or more particular areas or regions associated with operating environment 100.

As alluded to previously, in particular environments, such as indoor or like environments (e.g., urban canyons, etc.), for example, one or more IoT-type devices 102 may not be capable of acquiring and/or processing signals 104 from a sufficient number of SPS satellites 106 so as to perform a suitable positioning technique. Thus, optionally or alternatively, one or more IoT-type devices 102 may, for example, be capable of determining a position fix based, at least in part, on signals acquired from one or more local transmitters, such as femtocells, Wi-Fi access points, or the like. For example, one or more IoT-type devices 102 may obtain a position fix by measuring ranges to three or more local transceivers 112 positioned at known locations. In some implementations, one or more IoT-type devices 102 may, for example, measure ranges by obtaining a media access control (MAC) address from local transceiver 112 using one or more appropriate techniques.

In an implementation, one or more IoT-type devices 102 may, for example, receive positioning assistance data (e.g., OTDOA, AFLT assistance data, etc.) for one or more positioning operations from servers 116, 118, and/or 120. At times, positioning assistance data may include, for example, locations, identities, orientations, positioning reference signal configurations, etc. of one or more local transceivers 112, base station transceivers 108, etc. positioned at known locations for measuring ranges to these transmitters based, at least in part, on an round-trip time (RTT), time of arrival (TOA), time difference of arrival (TDOA), etc., or any combination thereof. In some instances, positioning assistance data to aid indoor positioning operations may include, for example, radio heat maps, context parameter maps, routeability graphs, etc., just to name a few examples. Other assistance data received by one or more IoT-type devices 102 may include, for example, electronic digital maps of indoor or like areas for display or to aid in navigation. For example, if an IoT-type device comprises a mobile device, a map may be provided to the mobile device as it enters a particular area, for example, and may show applicable features such as doors, hallways, entry ways, walls, etc., points of interest, such as bathrooms, pay phones, room names, stores, or the like. By obtaining a digital map of an indoor or like area of interest, a mobile IoT device may, for example, be capable of overlaying its current location over the displayed map of the area so as to provide an associated user with additional context, frame of reference, or the like.

According to an implementation, one or more IoT-type devices 102 may access navigation assistance data via servers 116, 118, and/or 120 by, for example, requesting such data through selection of a universal resource locator (URL). In particular implementations, servers 116, 118, and/or 120 may be capable of providing navigation assistance data to cover many different areas including, for example, floors of buildings, wings of hospitals, terminals at an airport, portions of a university campus, areas of a large shopping mall, etc., just to name a few examples. Also, if memory, data transmission and/or processing resources at one or more IoT-type devices 102 make receipt of positioning assistance data for all areas served by servers 116, 118, and/or 120 impractical or infeasible, a request for such data from one or more IoT-type devices 102 may, for example, indicate a rough or course estimate of a location of one or more IoT-type devices 102. One or more IoT-type devices 102 may then be provided navigation assistance data covering, for example, one or more areas including or proximate to a roughly estimated location of one or more IoT-type devices 102.

Even though a certain number of computing platforms and/or devices are illustrated herein, any number of suitable computing platforms and/or devices may be implemented to facilitate and/or support one or more techniques and/or processes associated with operating environment 100. For example, at times, network 122 may be coupled to one or more wired and/or wireless communication networks (e.g., WLAN, etc.) so as to enhance a coverage area for communications with one or more IoT-type devices 102, one or more base station transceivers 108, local transceiver 112, servers 116, 118, 120, or the like. In some instances, network 122 may facilitate and/or support femtocell-based operative regions of coverage, for example. Again, these are merely example implementations, and claimed subject matter is not limited in this regard.

Thus, as was indicated, one or more operations and/or techniques for infrastructure for securing and/or managing IoT-type devices may be implemented, at least in part, via a behavioral electronic document, which, in some instances, may comprise a behavioral manifest encoding a behavior of an IoT-type device. For example, in at least one implementation, a behavioral manifest may be divided into a number of sections that may be based, at least in part, on a prescribed or specified behavior of an electronic device, such as an IoT-type device. By way of example but not limitation, in certain simulations or experiments, eight sections of a behavioral manifest were used, though claimed subject matter is not so limited. For ease of discussion, the terms “behavioral electronic document,” “electronic document,” “document”, “behavioral manifest,” and “manifest” may be used interchangeable herein. Thus, consider, for example:

Document-Global Content Section. This section may comprise, for example, content that may be required or otherwise useful to facilitate and/or support some or most behaviors of an electronic device along with a security parameter. For example, a Document-Global Content Section may include the following content:
Document Structure Version.
Document Sequence Number.
List of Dependencies. This section may further include a List of Components affected by each Dependency. Typically, “component” refers to one or more computer files or a portion thereof to be used for storage of a firmware image or a part thereof, such as at a specified location (e.g., addressable, etc.). For example, a component may comprise a piece of software that may not necessarily be self-contained, but may be capable of being distributed independently or separately (e.g., an application, driver, network stack, etc.).
List of Components affected by a Document.

Common Behavior. As will also be seen, a common behavior process may be executed prior to each other behavior, for example, and may be used, in whole or in part, to make common decisions for all or most other behaviors.

Dependency Resolution Behavior. A dependency resolution behavior process may be used, in whole or in part, to ensure that all required or appropriate electronic documents have been collected, such as prior to attempting to acquire any firmware image, for example. It should be noted that this section may be optional in certain example implementations, such as if an electronic document has no dependencies, for example.

Image Acquisition Behavior. An image acquisition behavior process may, for example, be used, in whole or in part, to obtain one or more firmware images from local and/or remote sources and stage them for use by an IoT-type device. In some instances, such as if a Document lists no affected components, for example, then an image acquisition process may be optional. If an IoT-type device operates in a simultaneous Acquisition & Application mode (e.g., streaming and installation, etc.), then an image acquisition process may, for example, be replaced by an image application process, discussed below. At times, an image acquisition behavior process may, for example, be implemented, at least in part, in combination with one or more other processing operations, such as translation, symmetric cryptographic operations, decompression operations, unpacking operations, or the like, also discussed below.

Image Application Behavior. An image application behavior process may, for example, be used, at least in part, to place a firmware image into a long-term storage, such as a non-volatile memory, as one example. For example, an image may be moved from a staging area or from another source (e.g., a remote appliance, etc.) into a long-term storage. Likewise, similarly to an image acquisition behavior process, an image application behavior process may, for example, be implemented, at least in part, in combination with one or more other processing operations, such as translation, symmetric cryptographic operations, decompression operations, unpacking operations, or the like.

System Validation Behavior. A system validation behavior process may be used, at least in part, to ensure that all required or appropriate dependencies are present, for example, and that all required or appropriate images are present. In some instances, this process may, for example, be equivalent or similar to that used in a validation portion of one or more Secure Boot processes, as also discussed below.

Image Loading Behavior. An image loading behavior process may be used, at least in part, to ensure that all required or appropriate images are moved from long-term storage to active use storage (e.g., random access memory (RAM), processor cache, register, buffer, etc.). In some instances, this process may include, for example, copying a firmware image from internal or external source to RAM, such as defined by Component Information, just to illustrate one possible example. Likewise, an image loading behavior process may, for example, be implemented, at least in part, in combination with one or more other processing operations, such as translation, symmetric cryptographic operations, decompression operations, unpacking operations, or the like.

Image Invocation Behavior. This process may be used, at least in part, to finalize a manifest processor's behavior, for example, and forward execution to a designated component. At times, this operation may, for example, be equivalent or similar to a Bootloader process, also discussed below.

It should be noted that, depending on an implementation, some behavior processes may need only a single successful invocation. These one or more behavior processes may then be discarded, provided that Document serialization provides a mechanism to perform that process, for example. Typically, although not necessarily, discarded behaviors may include, for example, Dependency Resolution, Image Acquisition, and Image Application, just to name a few possible examples.

As was indicated, in some instances, one or more additional processing operations may, for example, be performed in combination with one or more behavior processes discussed above. For example, at times, an additional processing operation may include translation that may be performed, in whole or in part, on an image prior to its execution. These one or more operations may typically, although not necessarily, include, in order, one or more symmetric cryptographic operations, compression or decompression operations, and packing or unpacking operations, such as relocation, differential compression or decompression, and/or hex file interpretation, for example. In some instances, these or like operations may need or use additional information, such as which algorithm is in use and/or arguments to that algorithm, such as key identifiers for cryptographic operations, for example. Thus, at times, this or like information may be encoded in one or more appropriate Processing Step parameters. In some instances, processing step parameters and/or associated configuration may, for example, be scoped to an individual component or document.

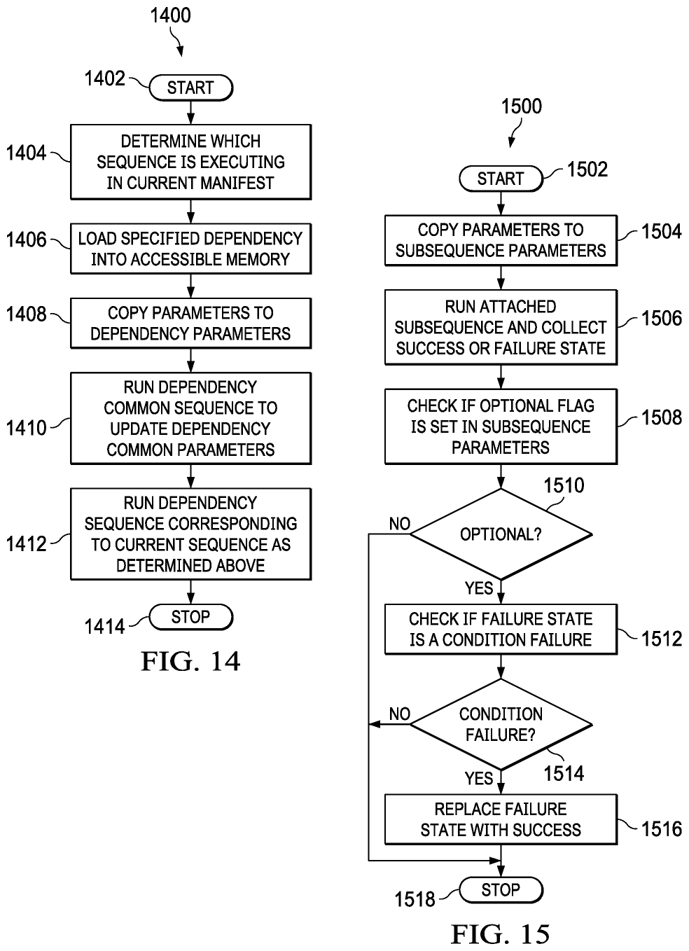

Continuing with the above discussion, in a behavioral electronic document, such as a behavioral manifest, for example, one or more required behaviors may be constructed as one or more lists of commands, with a particular command having one or more arguments (e.g., argument blocks for a particular type of command). Behaviors listed in specified sections may, for example, derive from a list of commands that may be defined via one or more command sequences. For example, a “command sequence” or “sequence” may define a series of actions that an IoT-type device must take to accomplish a particular goal. These goals may be defined in a manifest and may include, for example, Dependency Resolution, Payload Fetch, Payload Installation, Image Validation, Image Loading, Run or Boot, just to illustrate one possible implementation. At times, it may be useful for these or like goals to follow the same or very similar structure, such as to ensure that a parser is as simple as possible, for example. In one particular implementation, commands may, for example, be divided into two types, such as Conditions (e.g., verification operations that must be true—any failure may be treated as a failure of an update, load, boot) and Directives (e.g., action operations that must be executed). It should be noted that, at times, one or more optional conditions may be facilitated and/or supported. For example, a special directive may be provided and may run one or more new lists of conditions and/or directives, such as one after another, that are contained as an argument to the directive, just to illustrate one possible implementation. As such, in some instances, an update process may assume that a failure of a condition should not indicate a failure of an update and/or boot, for example, but a parameter may be provided to override this behavior, such as discussed below with reference to FIG. 15.

Thus, in an implementation, one or more lists of commands may, for example, be logically structured into sequences of zero or more conditions followed by zero or more directives. Thus, consider, for example:

Behaviour = [

+ {

conditions => [ * Condition],
directives => [ * Directive]

}

]

It should be noted that, for ease of discussion, the notational convention “Concise Data Definition Language” (CDDL) is employed herein, such as to define applicable protocols. See Henk Birkholz, Christoph Vigano, and Carsten Bormann, “Concise Data Definition Language (CDDL): A Notational Convention to Express CBOR and JSON Data Structures,” draft-ietf-cbor-cddl-08 (accessible at: https://tools.ietf.org/html/draft-ietf-cbor-cddl-08). Claimed subject matter is not limited to a particular notational convention, of course. In addition, even though a behavioral document and/or one or more associated processes are described in the context of firmware updates, such as, again, for ease of discussion, any other suitable technique associated with delivery and/or receipt of electronic content may be managed by applicable metadata or content, such as utilizing one or more operations and/or processes discussed herein.

Thus, continuing with the above discussion, in an implementation, conditions may, for example, form preconditions that must be true for the following sequence of directives to be executed. However, in certain simulations or experiments, it has been observed that, at times, this organization may introduce complexity in a parser, so the above structure may, for example, be flattened as follows:
Behaviour=[*(Condition/Directive)]

It should be noted that this operation does not alter a logical organization of sequences of preconditions that precede sequences of directives (e.g., on a list of commands, etc.), for example, but may advantageously simplify consumption of one or more commands in one or more applicable behaviors.

Depending on an implementation, conditions may, for example, include those illustrated below. Thus, consider, for example:

Verify device identity. This condition may be used, at least in part, to ensure that a document is being processed by an appropriate IoT-type device, for example, and/or to eliminate or reduce incompatibility failures. Identity may include, for example, what type of device is targeted, what software it uses, who created it, or the like. In some instances, identity may also include, for example, a particular IoT-type device that is targeted.

Verify image presence (e.g., correctness) or absence. This condition may, for example, be used, at least in part, in a document to ensure that a required firmware image is present in a specified component or location. This condition may include the use of one or more cryptographic checksums, such as to validate contents of an image contained in a component, for example.

Verify component properties. This condition may be used, at least in part, to verify one or more properties of a targeted file or component, such as, for example, a current nominal version of its application programming interface (API), base address offset that it may use, or the like.

Verify system properties. This condition may be used, at least in part, to verify one or more properties of an IoT-type device including, for example, a current power state, such as battery level, presence of external power, etc., a current time reported by a device, a current state of a controlled piece of applicable equipment, or the like.

Verify third party authorization. This condition may be used, at least in part, to ensure that a third party has approved a particular action, such as in a system-specific way. For example, this may be implemented, in whole or in part, via checking an applicable remote system (e.g., a server, etc.) for authorization, looking for a cryptographic token, invoking a user interface, or the like.

With respect to Directives, in an implementation, the following aspects may, for example, be used, in whole or in part:

Process sub-behaviors. In some instances, a decision must be made as to which of several behaviors should be invoked. To facilitate and/or support this, one or more sub-behaviors may, for example, provide a mechanism to permit soft-failure of a particular Condition. For example, a parameter of a sub-behavior may control its response to a Condition check failure, thus, allowing a command following a sub-behavior to be next to execute, or causing failure of the whole behavior, which may depend on its value, as will be seen. In some instances, this may, for example, allow for a construction of a conditional behavior. More specifically, as also discussed below, a sub-behavior may, for example, be invoked so as to allow one or more condition checks to soft-fail. Once one or more conditions that inform a conditional behavior have succeeded, for example, a soft-failure parameter may be switched to hard-failure so that further one or more condition failures may be detected. Likewise, particular examples of soft failure, hard failure, condition checks, or one or more other parameters will be discussed in greater detail below.

Process Dependencies. Dependencies may need careful handling on resource constrained IoT-type devices. For example, a dependency tree that is too deep may cause recursive handling to overflow stack space. Devices that parse all dependencies into an object tree, for example, may more easily fill up available memory, and too many dependencies may overrun available storage space. Depending on an implementation, dependencies may be processed via, for example, iterating by component, iterating by manifest, or out-of-order. Because a manifest comprises a list of components and a list of components defined by its dependencies, for example, it may be possible for a manifest processor to handle one component at a time, thus, traversing a manifest tree once for a listed component. In some instances, this may, however, consume significant processing power. Optionally or alternatively, it may be possible for a device with sufficient memory to accumulate all or most parameters for all or most listed component IDs. At times, this may consume more memory, for example, but may allow a device to process a manifest in a single pass.

In some instances, dependencies may, for example, be processed by invoking two behaviors within a dependency; namely, first, a common behavior may be invoked, then a behavior matching a current behavior of a current document may be invoked. As such, if an “Image Application” behavior is active when a “Process Dependencies” behavior is invoked, for example, then each dependency's “Common” behavior will be invoked, followed by its “Image Application” behavior. In some instances, it may be advantageous to process dependencies in a particular order, such as specified in a document, for example. At times, a failure of processing of any dependency may, for example, result in a failure of a “Process Dependencies” behavior. As discussed below, more advanced devices may make use of a Strict Order parameter, for example, so as to implement parallel processing of some segments, or it may reorder some segments. To perform parallel processing, once a Strict Order parameter is set to False, a device may fork a process for each command, for example, until the Strict Order parameter is returned to True or the command sequence ends. Then, it may join all forked processes before continuing processing of commands. To perform out-of-order processing, a similar approach may be used, except a device may consume all commands after a Strict Order parameter is set to False, for example, then it may sort these commands into its preferred order, invoke them all, then continue processing.

Set Parameters. Many Commands may be partially governed by configuration present in the form of one or more parameters. For example, parameters may control a source used for Image Acquisition, one or more processing operations applied to those one or more images, an order in which commands may be processed, or the like. Parameters may be set in a number of ways. For example, in one particular implementation, parameters may include the following: set-if-unset (the default), append-if-set (typically used for source lists), and set-always (used for critical parameters). Parameters may be either global or scoped by Component or Component Group. Particular examples of parameters that may be used, in whole or in part, to facilitate and/or support for infrastructure for securing and/or managing IoT-type devices will be discussed in greater detail below.

Move an Image. This Command may, for example, direct a document processor to acquire an Image or Document and store it to a specified Component or Document storage, respectively. A source may be local or remote, for example, or may comprise a prioritized list of local and remote sources. A source or source list may be specified via a source parameter, for example. An image or document may optionally or alternatively be modified in transit by a sequence of processing operations, as also discussed below.

Invoke an Image. This command may forward execution to a specified firmware image, such as similarly to a bootloader, as will be seen. As with bootloaders, semantics of forwarding execution and/or argument may be application-defined. An argument may, for example, be provided to an Image.

Wait for an Event. In some instances, a particular behavior may need to wait for a property of an IoT-type device to change. Depending on an implementation, this may be a message from a remote system, a time, a power state, a user interaction, and/or some other system parameter.

As indicated above, in some instances, one or more processing steps parameters may, for example, be employed, in whole or in part, to facilitate and/or support one or more operations and/or techniques for infrastructure for securing and/or managing IoT-type devices. For example, as discussed above, one or more processing steps parameters may be encoded in a behavioral document so as to provide additional information for a particular processing operation to be applied to a firmware image, such as which algorithm is in use or arguments to that algorithm, key identifiers for cryptographic operations, or the like. In some instances, device identity may also be denoted or specified via an appropriate processing step parameter, as was also indicated. Thus, in an implementation, the following parameters may be used, in whole or in part, or otherwise considered:

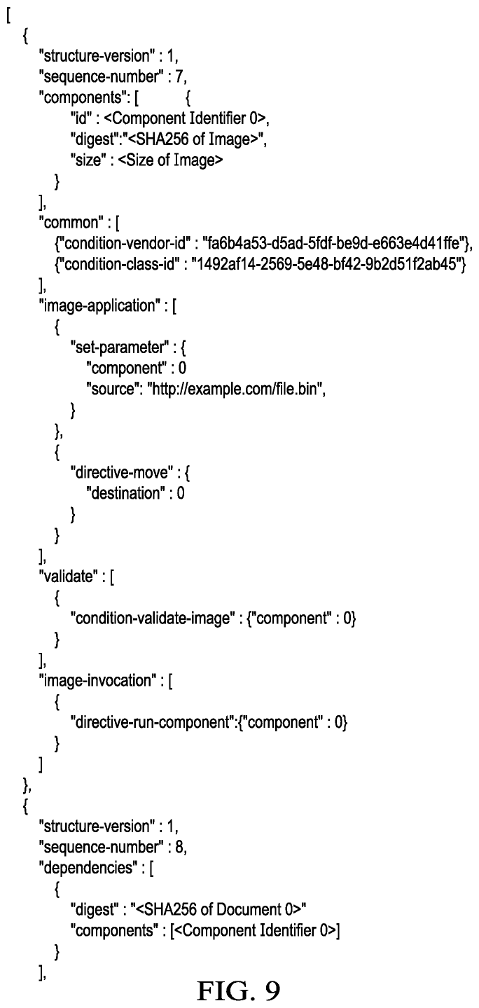

Strict Order. Some IoT-type devices, such as a bootloader, for example, may have particular requirements regarding command ordering within a behavior. Other more advanced IoT-type devices, such as a more advanced installer or updater, for example, may be capable of facilitating and/or supporting reordering and/or parallel execution of commands. If a Strict Order parameter is set to False, these one or more extended update capabilities may be enabled. A more advanced IoT-type device may then aggregate all successive commands up until a behavior ends or a Strict Order parameter is returned to True and process those commands in parallel or reorder them as it requires. Strict Order may, for example, default to True. If an IoT-type device does not support command reordering or parallel processing, such as a bootloader, for example, Strict Order=False may have no effect. Particular examples of a bootloader, simple updater, and more advanced updater, respectively, will be discussed in greater detail below, such as with reference to FIGS. 10-12, for example.

Soft Failure. If an IoT-type device invokes a sub-behavior, as discussed above, a condition check failure and a directive failure may, for example, cause a behavior to immediately abort. However, if a Soft Failure parameter is True, for example, then an abort due, at least in part, to a condition failure may not cause a sub-behavior to report failure. If a Soft Failure parameter is True, such as indicating hard failure, for example, then an abort may cause a sub-behavior to report failure as well.

Source List. A source list may, for example, be scoped to an individual component or dependency. In some instances, it may comprise, for example, a prioritized search path for a Move command to use in order to find an image and/or document. It may contain one or more local sources, such as other components, for example, or one or more remote ones, such as Uniform Resource Identifiers (URIs) or the like.

Processing Step Configurations. As was indicated, a number of processing operations may require configuration to operate, for example, or configuration may inform whether or not to use them. Typical processing operations may include, for example, symmetric cryptography, compression and/or decompression operations, packing and/or unpacking, relocation, differential compression, hex file interpretation, or the like. Processing step configuration may, for example, scoped to an individual component or document.

Image Identifier. In order to determine whether an image is present, a verify image presence condition may require an identifier for the image. This may comprise be a version number or a cryptographic identity, such as a digest, for example.

In some instances, such as if one or more operations and/or techniques involve distribution of firmware updates and/or invocation of complex behaviors on an electronic device, for example, it may be required or otherwise useful to authenticate contents of a behavioral electronic document, such as a behavioral manifest. Thus, to manage permissions in these or like documents, a number of approaches may be employed, in whole or in part. For example, depending on an implementation, the following approaches may be used, at least in part, or otherwise considered:

One approach may require that all documents are authenticated by a single identity. This approach may have an advantage that only a single document may need to be authenticated, for example, since each document's dependencies may be uniquely identified in that document. At times, this approach may be extended by adding key delegation without a substantial increase in complexity.

Another approach may require an access control list (ACL) to be presented to a device, authenticated by a trusted party, or stored on the device. This ACL may grant access rights for specific Components and/or Component Groups to one or more listed identities or identity groups. An identity may verify that an image is present, for example, but Moving an image into or out of a Component may require approval from an ACL.

Yet another approach may allow a Document Processor to provide more fine-grained controls. For example, an ACL may list a Component or Component Group that an identity may use, and may also list one or more commands that the identity may use in combination with that Component or Component Group.

Thus, by way of example but not limitation, according to an implementation, an image installation process and an image invocation process may, for example, be represented via workflows illustrated below. It should be noted that a particular operation represented herein may already be present in a device capable of firmware update or secure boot. The example approaches illustrated may, thus, define a mechanism by which these one or more operations may be orchestrated, for example, and may enforce or show with particularity that a behavior of a device may be precisely defined by a Behavioral Document, rather than imprecisely described via associated information, as was indicated. As illustrated, here, a common component, such as do_commands may be used. Thus, consider, for example:

function do_commands(section, sequence)

rs = SUCCESS
foreach (command in $sequence)

choose $command[Type]:

case Sub-Behaviour:

Load commands = $command[Argument] [commands]
Load parameters = System Parameters
Load soft_failure = $parameters[Soft Failure]
Call rc = do_commands(commands)
if (soft_failure AND is_condition_failure(rc))

rc = SUCCESS

endif

endcase
case Process Dependency:

; Note Dependency selection can be done via argument or
; parameter. May process multiple dependencies in a list.
Load Dependency
Load common = $Dependency[Common Sequence]
Call rc = do_commands(Common, $common)
if (rc is SUCCESS?}

Load $sequence = $Dependency[$section]
Call rc = do_commands($section, $sequence)

endif

endcase
case Set Parameters:

Load parameter_list = $command[Argument] [Parameter List]
foreach (parameter in parameter_list)

if (is_append(parameter)?)

Append argument value to $parameter

elseif (is_set($parameter[Name]))

Set $parameter[Name] = $parameter[Value]

endif

endfor

endcase
case Move:

; Note Component selection can be done via argument or
; parameter. May process multiple components in a list.
; Note Dependency selection can be done via argument or
; parameter. May process multiple dependencies in a list.
; Source

Load component_list = $command[Argument] [Component List]
Load dependency_list = $command[Argument] [Dependency List]
foreach (target_list in [component_list, dependency_list])

foreach (target in $target_list}

Load $target parameters
Set source = choose_best_source($parameters[Source List])
Acquire data from $source
foreach (processing_step in $parameters[Processing Step Configuration])

rc = Process_Data($processing_step, $data)

endfor
Store $data to $target

endfor

endfor

endcase
case Invoke:

; Note Component selection can be done via argument or
; parameter. May process multiple components in a list.
Select component
Load Argument = $command[Argument]
Transfer execution to $component with $Argument;

endcase
case Wait:

Load arguments = $command[Argument] [Wait Arguments]
Load type = $command[Argument] [Wait Type]
Wait ($type, $arguments)

endcase
case Device Identity:

; Note Device Identity selection can be done via argument or
; parameter. May process multiple Device Identities in a list.
Load device_identity = $parameters[Device Identity]
if ($device_identity is nil)

Load device_identity = $command[Argument] [Device Identity]

endif
rc = Compare $device_identity to $parameters

endcase
case Image Present/not Present:

; Note Component selection can be done via argument or
; parameter. May process multiple components in a list.
; Note Dependency selection can be done via argument or
; parameter. May process multiple dependencies in a list.
Load component_list = $command[Argument] [Component List]
Load dependency_list = $command[Argument] [Dependency List]
foreach (target_list in [component_list, dependency_list])

foreach (target in $target_list)

Load $target parameters
Set image_identifier = $parameters[Image Identifier]
rc = Compare $component to $image_identifier;

endfor

endfor

endcase
case Verify Authorisation

Request authorisation
Wait for authorisation
rc = Check Response

endcase

endchoose

endwhile (no)

endfunction

In at least one implementation, Installation may, for example, be represented via the following:

function install(Document)

Load $Document[Common Data] into parameters
foreach (sequence in [Common, Dependency Resolution, Image
Acquisition, Image Application])

rc = do_commands($sequence, $Document[$sequence]);
if (rc is not SUCCESS)

Abort

endif

endfor

endfunction

Further, according to an implementation, Image Invocation may, for example, be represented as:

function invoke(Document)

Load $Document[Common Data] into parameters
foreach (sequence in [Common, System Validation, Image Loading,
Image Invocation]}

rc = do_commands($sequence, $Document[$sequence]);
if (rc is not SUCCESS)

Abort

endif

endfor

endfunction

In an implementation, a behavioral manifest may, for example, be implemented to work with (e.g., be interpreted by) a pull parser, where each section of the manifest may be used in sequence. In some instances, such as if multiple manifests are used for an update, for example, each manifest's operations may occur in a lockstep fashion, and all manifests may have dependency resolution performed before any manifest performs a payload fetch, etc.

Thus, in operative use, having received or accessed a behavioral manifest, an IoT-type device may implement the following workflow, such as in the context of a firmware update, for example:
Verify a signature of a manifest.
Verify applicability of a manifest.
Resolve dependencies.
Fetch one or more payloads. Here, “payload” refers to electronic content to be delivered to or accessed by an electronic device (e.g., a firmware, etc.).
Install one or more payloads.

In some instances, such as if installation is complete, for example, similar information may be used, at least in part, for validating and/or running firmware images for the following processes:
Verify image(s).
Load image(s).
Run image(s).

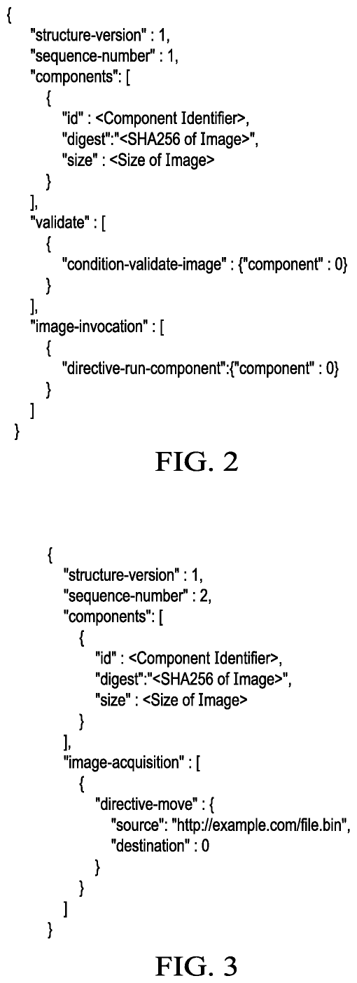

With this in mind, attention is now drawn to FIGS. 2-9, which are examples of an implementation of functionalities of a behavioral document, such as a behavioral manifest, such as specifying or defining particular example behaviors in the context of a firmware update. It should be noted that, even though example behaviors are specified or defined in connection with a JavaScript Object Notation (JSON), such as for readability, in some instances, JSON may not be appropriate or otherwise useful for certain resource constrained devices.

Thus, FIG. 2 illustrates an example of an implementation of a functionality of a behavioral manifest for booting a firmware image, such as on an execute-in-place (XIP) processor. For purposes of explanation, typically, an XIP process may execute a process directly from long term storage, such as rather than copying it into RAM, for example, which, in some instances, may reduce the total amount of memory required.

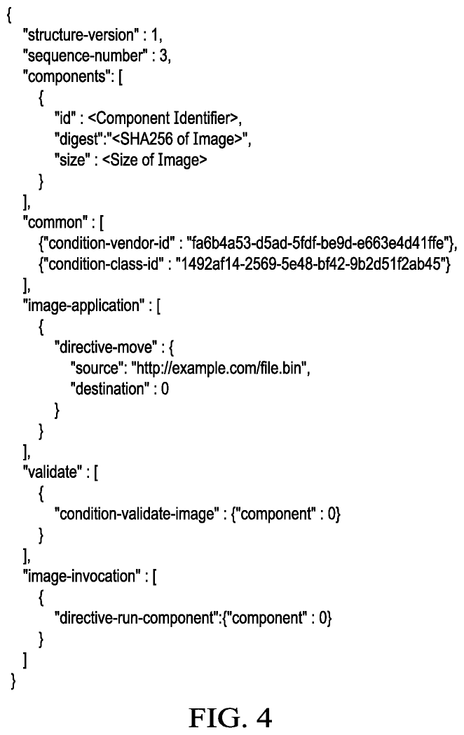

Further, FIG. 3 illustrates an example of an implementation of a functionality of a behavioral manifest for downloading a firmware image.

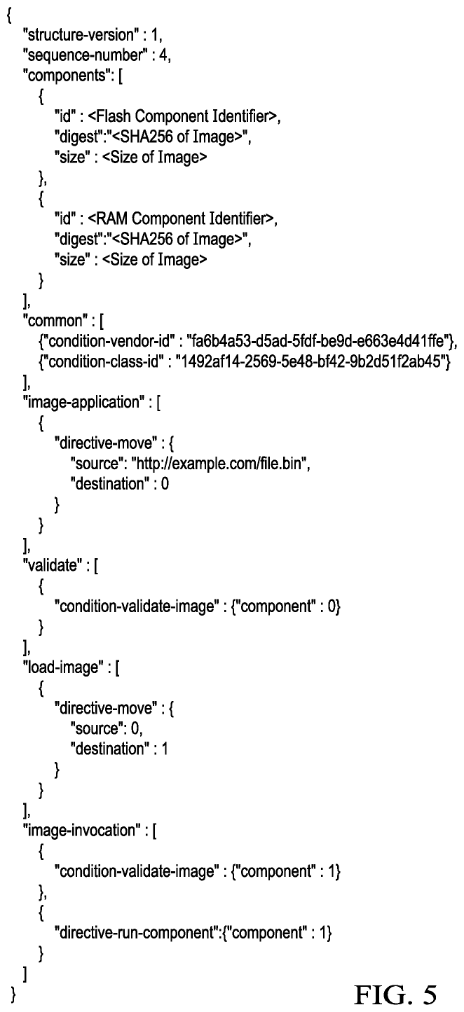

Next, FIG. 4 illustrates an example of an implementation of a functionality of a behavioral manifest for checking compatibility, downloading, and booting a firmware image.

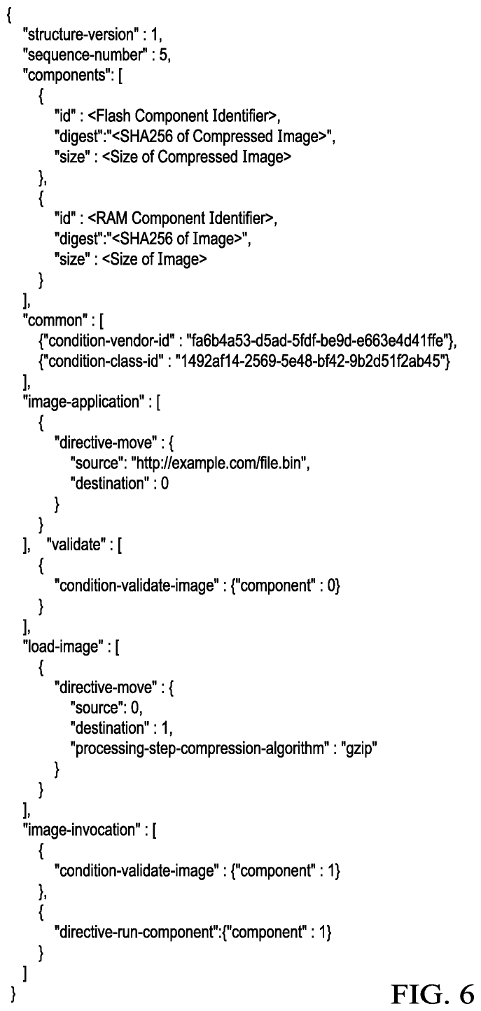

Next, FIG. 5 illustrates an example of an implementation of a functionality of a behavioral manifest for checking compatibility, downloading, loading from an external source, and booting a firmware image.

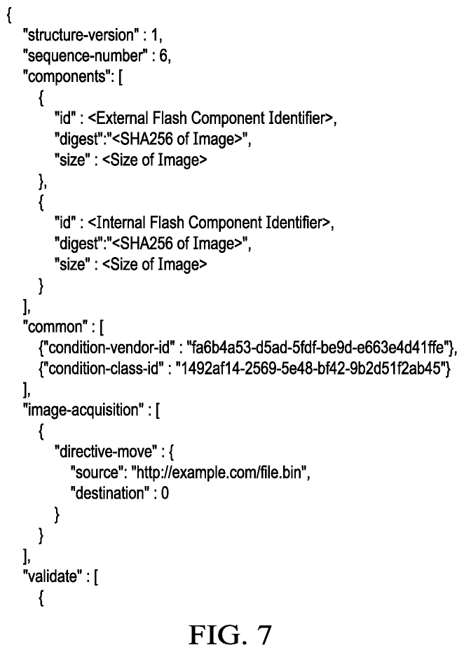

Next, FIG. 6 illustrates an example of an implementation of a functionality of a behavioral manifest for checking compatibility, downloading, loading with decompress, and booting a firmware image. As was indicated, decompression may comprise an optional operation that may, for example, be defined via one or more processing step parameters.

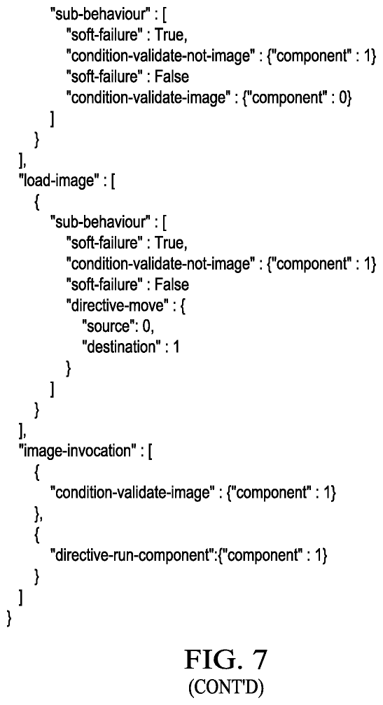

Next, FIG. 7 illustrates an example of an implementation of a functionality of a behavioral manifest for checking compatibility, downloading, installing from an external source, and booting a firmware image.

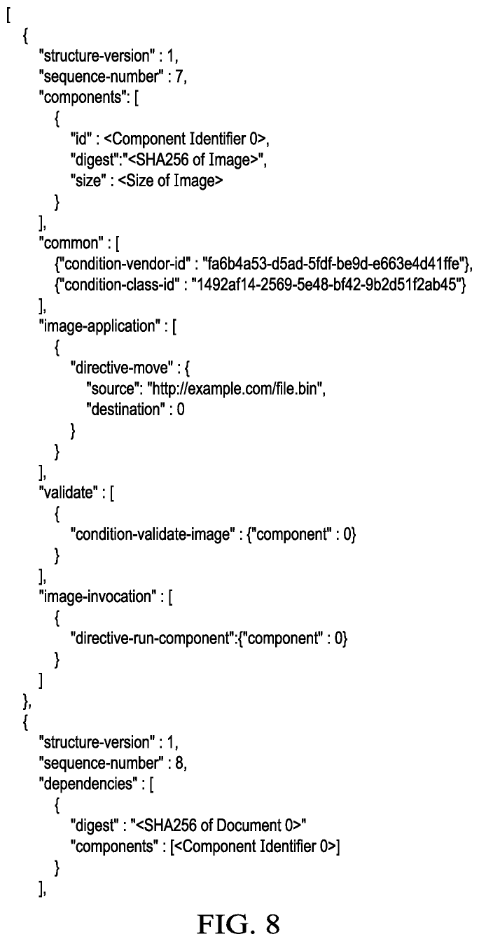

Next, FIG. 8 illustrates an example of an implementation of a functionality of a behavioral manifest for downloading and booting a firmware image with a dependency.

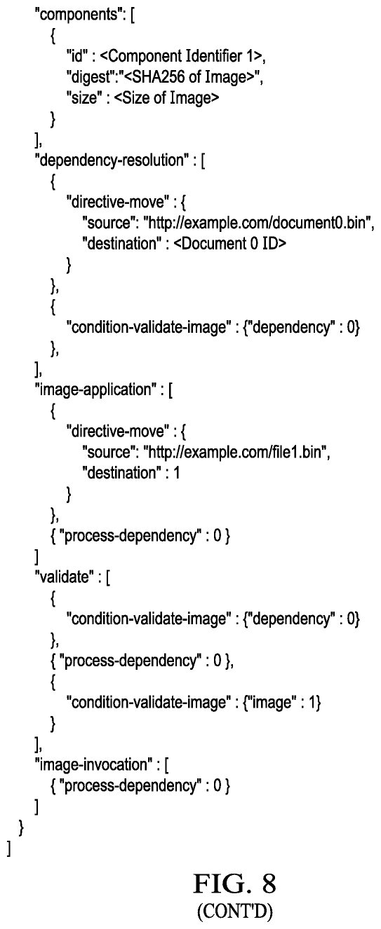

Next, FIG. 9 illustrates an example of an implementation of a functionality of a behavioral manifest for downloading and booting a firmware image with a dependency using override. Override may, for example, fetch location for dependency.

Referring now to FIG. 10, which is a flow diagram of an implementation of an example use case or scenario 1000 that may be employed, in whole or in part, to facilitate and/or support one or more operations and/or techniques for infrastructure for securing and/or managing IoT-type devices. As was indicated and as discussed below, in some instances, use case or scenario 1000 may, for example, be implemented, at least in part, via a resource constrained IoT-type device, such as via a bootloader or like process. In at least one implementation, a bootloader may comprise, for example, a relatively minimal process, such as capable of evaluating conditions or implementing checks (e.g., verifying a manifest, etc.) and executing directives (e.g., sequences, etc.), such as without changes to non-volatile memory. For example, in a particular implementation, a bootloader may comprise command handlers, flash support, one or more cryptographic primitives, and/or an optional recovery mechanism. It should be noted, however, that this is just one particular example of a bootloader that may be used herein, at least in part, or otherwise considered, and that claimed subject matter is not so limited. It should also be noted that information acquired or produced, such as, for example, input signals, output signals, operations, results, etc. associated with example use case or scenario 1000 may be represented via one or more digital signals. It should also be appreciated that even though one or more operations are illustrated or described concurrently or with respect to a certain progression, other progressions or concurrent operations may be employed. In addition, although the description below references particular aspects or features illustrated in certain other figures, one or more operations may be performed with other aspects or features.

Thus, example process 1000 may, for example, begin at operation 1002 and may proceed to operation 1004, such as to find or obtain a particular manifest of interest. As was indicated, depending on an implementation, a manifest may, for example, be electronically communicated or otherwise accessible to an IoT-type device, such as via one or more appropriate techniques (e.g., push, pull, etc. technology). Thus, as illustrated in this particular implementation, in some instances, a manifest of interest may comprise, for example, the latest authentic manifest encoded with a supported version of a specification, such as to confirm authority and/or authenticity of an associated firmware prior to execution. For example, here, an IoT-type device may access an ACL, discussed above, such as comprising a table of Identities and Component Identifier permissions to ensure that a current manifest is the latest manifest received or obtained (e.g., via versioning, sequencing, etc. information), for example. An IoT-type device may further ensure that a current manifest has been authenticated by an appropriate identity (e.g., via an authentication code, signature, etc.), such as for the manifest to have access to operate on or define a component, for example. To facilitate and/or support this, in some instances, an outer wrapper or like object (e.g., authentication wrapper, etc.), such as in the form of a signed container encapsulating a manifest and providing a common mechanism for authentication or other information (e.g., references to other objects, etc.), for example, may be used herein, in whole or in part, or otherwise considered. It should be noted that claimed subject matter is not limited to a particular authentication, signing, etc. approach, and that any suitable authentication, signing, etc. approach may be employed herein, in whole or in part.

With regard to operation 1006, having found an appropriate manifest, common content may, for example, be loaded, such as into a suitable in-memory appliance (e.g., a buffer, etc.) for the purposes of accessing associated information of interest in a more efficient and/or more effective manner (e.g., faster, multiple times, etc.), if suitable or desired. For example, common content may be loaded from one or more lists associated with a manifest. Thus, instead of making another copy of an applicable list, here, a reference may, for example, be made to the beginning of that list so as to allow an IoT-type device to refer back into the list, if needed. By way of example but not limitation, in certain simulations or experiments, a manifest comprised a list of dependencies, a list of components, a list of dependency components, and a common sequence list, which were used, at least in part, to load common content. To illustrate, a list of dependencies may comprise, for example, one or more blocks that may specify one or more manifests that must be present before a current manifest may be processed. A list of components may comprise, for example, one or more blocks that may specify one or more component identifiers that may be affected by content of a current manifest. A list of dependency components may comprise, for example, one or more blocks that may specify one or more component identifiers that may be affected by content of a dependency of a current manifest. A common sequence list may comprise, for example, a Command Sequence for an IoT-type device to execute, such as prior to executing any other commands. Typical actions in a common sequence list may include, for example, setting expected device identity, image digests (e.g., if they are conditional), or the like. Of course, claimed subject matter is not limited to particular lists shown.

Continuing with the above discussion, at operation 1008, example process 1000 may, for example, reset one or more parameters, may run or execute a Common Sequence, such as via a respective command, so as to initialize one or more common parameters, and may also run a Verify Sequence. For example, one or more parameters that may be present (e.g., left over) from a previous execution or run, if any, may be reset, such as deleted or purged, since these parameters may not be applicable to or useful for one or more executions at operation 1008 (e.g., Common Sequence, Verify Sequence, etc.). As such, here, an operating environment for a bootloader may be reset, such as by initializing one or more common parameters to the expected Common state, for example. As also illustrated, here, a Verify Sequence may, for example, be executed, such as to verify a firmware image (e.g., image presence, properties, etc.), as discussed above. Generally, a run sequence process, such as for image verifying, loading, running, etc. may comprise, for example, an iterative or loop-type process with a suitable number of iterations or repetitions as a result of one or more decisions, such as whether there is a need to process one or more additional commands. To illustrate, while executing a run sequence, if it is determined that more commands may need to be processed, for example, an appropriate command processing function or process that corresponds to a command ID for a current command may be executed. Such a run sequence process may, for example, be implemented for various commands, such as discussed herein (e.g., verify image, load image, run image, dependency resolution, image fetch, image install, etc.), in a similar manner.

Example process 1000 may further proceed to operation 1010, such as, for example, to reset one or more parameters, rerun a Common Sequence, and execute an Image Load Sequence. Here, similarly to operation 1008, one or more parameters that may be left over from a previous run (e.g., at operation 1010, etc.) may be reset and reinitialized, such as in a similar manner, via re-executing a Common Sequence, for example. Subsequently, a firmware image may, for example, be loaded such as via executing an Image Load Sequence. For example, in some instances, an Image Load sequence may be run in order to prepare a firmware image for execution. As a way of illustration, a firmware image may, for example, be copied into RAM, decrypted, decompressed, or the like, such as discussed above in connection with an image loading behavior.

With regard to operation 1012, likewise, one or more left over parameters may be reset and reinitialized, such as via rerunning a Common Sequence, for example, in a similar manner. As also seen, subsequently, a Run Image Sequence may be executed, such as via an appropriate command, for example. For example, as was indicated, here, a command may forward execution of a firmware image to a designated component. As also discussed above, semantics of forwarding execution and/or argument may be application-defined, for example, and an argument may be provided to an Image. Subsequently, such as having executed an Image Run Sequence, example process 1000 may terminate, such as referenced generally at 1014.

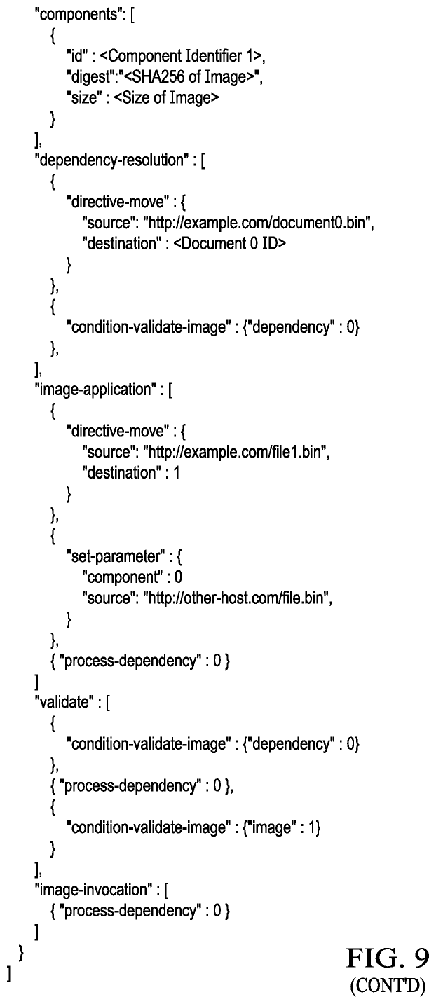

Referring now to FIG. 11, which is a flow diagram of an implementation of an example use case or scenario 1100 that may be employed, in whole or in part, to facilitate and/or support one or more operations and/or techniques for infrastructure for securing and/or managing IoT-type devices. In some instances, use case or scenario 1100 may be implemented, at least in part, via an IoT-type device having sufficient processing resources to implement a specified or defined firmware update, such as via one or more changes to non-volatile memory, for example, utilizing a simple updater or like process. For example, in at least one implementation, a simple updater may comprise an IoT-type device having sufficient memory resources so as to be able to handle one update process at a time, such as specified via a manifest. It should be noted, however, that this is just one particular example of a simple updater that may be used herein, at least in part, or otherwise considered, and that claimed subject matter is not so limited. It should also be noted that information acquired or produced, such as, for example, input signals, output signals, operations, results, etc. associated with example use case or scenario 1100 may be represented via one or more digital signals. It should also be appreciated that even though one or more operations are illustrated or described concurrently or with respect to a certain progression, other progressions or concurrent operations may be employed. In addition, although the description below references particular aspects or features illustrated in certain other figures, one or more operations may be performed with other aspects or features.

Thus, as illustrated, example process 1100 may begin at operation 1102 and may proceed to implement operations 1104 and 1106, such as in a manner similar to operations 1004 and 1006 of FIG. 10, respectively. For example, in an implementation, example process 1100 may find the latest manifest that is authentic and is encoded with a supported version of a specification, and may load common content into a suitable in-memory appliance, such as for the purposes of accessing appropriate information in a more efficient and/or more effective manner. At operation 1108, one or more parameters that may be left over from a previous execution or run may be reset, for example, and a Common Sequence may be run to initialize one or more common parameters, as also discussed above in connection with operation 1008 of FIG. 10. Subsequently, here, example process 1100 may, for example, run or execute a Dependency Resolution Sequence, such as according to dependency resolution behavior discussed above. For example, in some instances, a Dependency Resolution Sequence may comprise a command that may be executed in order to perform dependency resolution, such as if one or more dependencies are present. As also discussed, typical actions may include, for example, configuring URIs of dependency manifests, fetching dependency manifests, validating dependency manifests' contents, or the like.

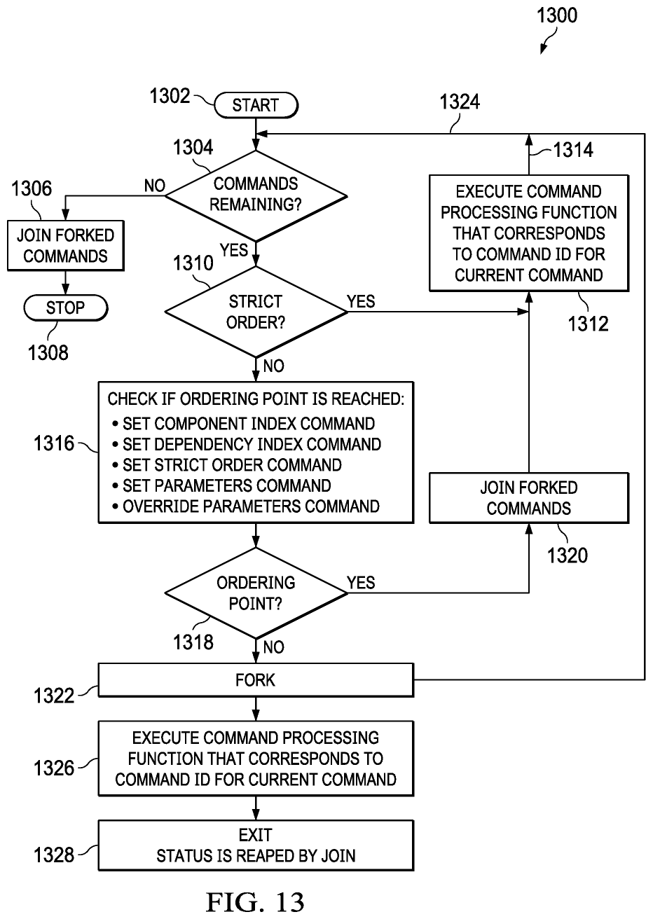

In an implementation, a duplicate copy of all applicable parameters may be made, such as while dependency processing is invoked during execution of a Dependency Resolution Sequence, for example, and used, at least in part, to update the dependency common parameters, such as via running a dependency's common sequence in the duplicate copy of the parameters. Example process 1100 may then run or execute a Dependency Resolution Sequence in a dependency identified at the time the dependency process was invoked. At times, this may, for example, facilitate and/or support more secure processing, such as via preventing potential parameter modifications while implementing a firmware update. A particular example of this process will be discussed in greater detail below with reference to FIG. 14.

According to an implementation, example process 1100 may further proceed to operation 1110, such as, for example, to reset one or more parameters, rerun a Common Sequence, and run or execute an Image Fetch Sequence. Here, similarly to operation 1108, one or more parameters that may be left over from a previous run (e.g., at operation 1110, etc.) may be reset and reinitialized, such as in a similar manner, via re-executing a Common Sequence, for example. Subsequently, a firmware image may be obtained, such as specified via a manifest index and/or component index, for example, via executing an Image Fetch Sequence. For example, as indicated above, a manifest processor associated with an IoT-type device may retrieve one or more applicable components and/or manifests listed in these or like indices and may fetch one or more current manifest components and/or manifests. At times, a manifest processor may also read a URI and/or URI List parameter to find a source of a fetch, for example. In addition, as discussed above, in some instances, here, one or more commands in a common section of the current dependency may be executed, such as followed by one or more commands in a duplicate copy (e.g., an equivalent section, etc.) of the current dependency. For example, prior to completing an Image Fetch Sequence, a common sequence in the current dependency may be executed, such as followed by execution of an Image Fetch Sequence in the current dependency.

With regard to operation 1112, likewise, one or more left over parameters may be reset and reinitialized, such as via rerunning a Common Sequence, for example, in a manner similar to operations 1108 and 1110 above. As also seen, subsequently, an Image Install Sequence may be executed, such as via an appropriate command, for example, to install a firmware update. For example, such a command may initiate verifying that an image is stored in a temporary storage, copying a staged image from a temporary storage, unpacking an image, or the like. Subsequently, such as having executed an Image Install Sequence, example process 1100 may terminate, such as referenced generally at 1114.

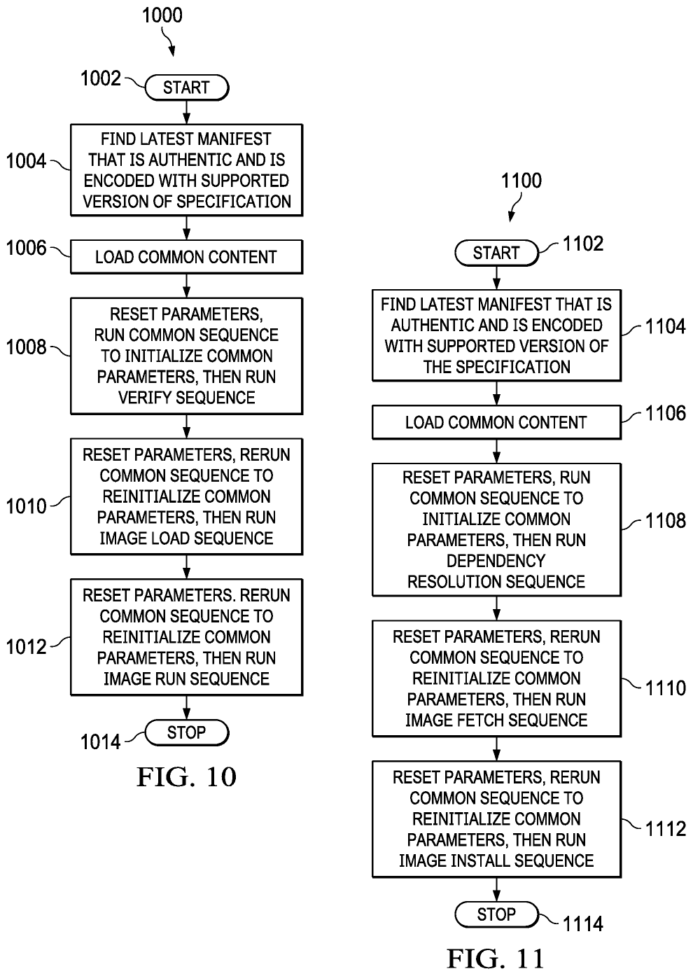

Referring now to FIG. 12, which is a flow diagram of an implementation of an example use case or scenario 1200 that may be employed, in whole or in part, to facilitate and/or support one or more operations and/or techniques for infrastructure for securing and/or managing IoT-type devices. In some instances, use case or scenario 1200 may be implemented, at least in part, via an IoT-type device having more advanced processing resources (e.g., an advanced update capability, etc.) to implement a specified or defined firmware update, such as via one or more changes to non-volatile memory, for example, utilizing an advanced updater or like process. For example, in at least one implementation, an advanced updater may comprise an IoT-type device having more advanced memory resources, such as a memory management unit (MMU), just to illustrate one particular non-limiting example, so as to be able to execute directives out of order (e.g., reorder segments, etc.) and/or parallelize processing of updates (e.g., implement parallel processing of segments, etc.). It should be noted, however, that this is just one particular example of an advanced updater that may be used herein, at least in part, or otherwise considered, and that claimed subject matter is not so limited. It should also be noted that information acquired or produced, such as, for example, input signals, output signals, operations, results, etc. associated with example use case or scenario 1200 may be represented via one or more digital signals. It should also be appreciated that even though one or more operations are illustrated or described concurrently or with respect to a certain progression, other progressions or concurrent operations may be employed. In addition, although the description below references particular aspects or features illustrated in certain other figures, one or more operations may be performed with other aspects or features.

Thus, as illustrated, example process 1200 may begin at operation 1202, for example, and may proceed to implement some actions for operations 1204 through 1212 in a manner similar to operations 1104 through 1112, respectively, such as described in connection with example process 1100 of FIG. 11. For example, according to an implementation, similarly to example process 1100 of FIG. 11, example process 1200 may obtain the latest manifest that is both authentic and is encoded with a supported version of a specification, such as at operation 1204, and may proceed to operation 1206 to load common content. Likewise, example process 1200 may further proceed to operation 1208 so as to reset one or more parameters, for example, and run a Common Sequence to initialize one or more common parameters, such as similarly to operation 1108 of FIG. 11. According to an implementation, example process 1200 may further proceed to operation 1210, such as, for example, to reset one or more parameters and rerun a Common Sequence to initialize one or more common parameters (e.g., left over from operation 1208, etc.), such as similarly to operation 1110 of FIG. 11. With regard to operation 1212, likewise, one or more left over parameters may be reset and reinitialized, such as via rerunning a Common Sequence, for example, in a manner similar to operation 1112 above.

As also seen and as discussed below, in some instances, however, unlike example process 1100, example process 1200 may run or execute one or more applicable sequences, such as Dependency Resolution, Image Fetch, and Image Install, for example, such as using asynchronous processing. For example, as was indicated, asynchronous processing may allow a particular IoT-type device, such as an IoT-type device having more advanced processing resources (e.g., an advanced update capability, etc.) to choose the order in which command sequences are executed and/or parallelize handling of updates, such as via a Strict Order parameter.

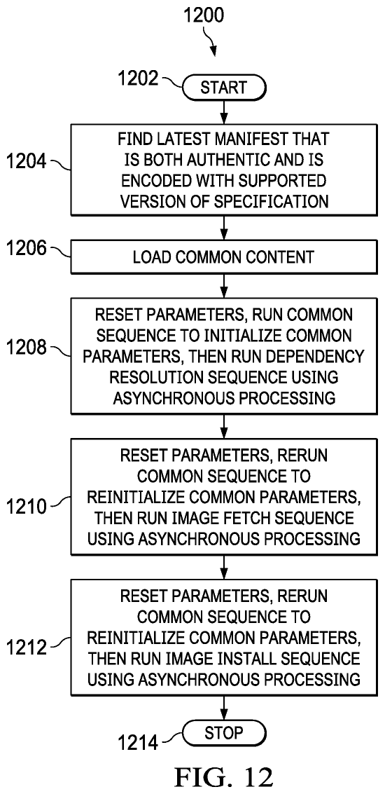

Thus, attention is now drawn to FIG. 13, which is a flow diagram of an implementation of an example process 1300 that may be employed, in whole or in part, to facilitate and/or support one or more operations and/or techniques for infrastructure for securing and/or managing IoT-type devices, such as via asynchronous processing. For example, in some instances, example process 1300 may be implemented, at least in part, in connection with operations 1208, 1210, and/or 1212 of FIG. 12, such as in connection with executing Dependency Resolution, Image Fetch, and/or Image Install sequences, as was indicated. It should be noted that information acquired or produced, such as, for example, input signals, output signals, operations, results, etc. associated with example process 1300 may be represented via one or more digital signals. It should also be appreciated that even though one or more operations are illustrated or described concurrently or with respect to a certain progression, other progressions or concurrent operations may be employed. In addition, although the description below references particular aspects or features illustrated in certain other figures, one or more operations may be performed with other aspects or features.

Thus, example process 1300 may begin at operation 1302, for example, and may proceed to operation 1304, such as for a determination whether there are any commands remain for execution, such as from one or more associated forked processes. Typically, a “fork” comprises an operation in which a process creates a copy of itself or proxy. If it is determined that no commands are left to execute, example process 1300 may terminate, as referenced at operation 1308. As illustrated at 1306, in some instances, such as prior to termination, example process 1300 may, for example, join forked commands (e.g., from previous loops, etc.), such as to implement their parallel processing (e.g., at operation 1208, 1210, 1212, etc.). If yes, example process 1300 may proceed to operation 1310, such as to determine if a Strict Order parameter is set to True. If yes, example process 1300 may proceed to operation 1312, such as, for example, to execute a command processing function corresponding to a command ID for a current command. Here, a particular command (e.g., Dependency Resolution, Image Fetch, and/or Image Install of FIG. 12, etc.) may be executed in order, such as one at a time, for example. As further illustrated at 1314, example process 1300 may loop back to operation 1304, such as to repeat one or more operations of example process 1300, such as discussed herein, if appropriate.

If a Strict Order parameter is set to False, for example, such as determined at operation 1310, example process 1300 may proceed to operation 1316, such as to check if an ordering point has been reached. For example, it may be determined that an ordering point has been reached if there are no commands left that may be processed out of order without affecting an underlying update process on a global state (e.g., safely, without changing fundamental properties of commands, aborting a behavior, etc.). Thus, in at least one simulation or experiment, it has been determined that an ordering point has been reached (e.g., no more commands may be “forked” or processed asynchronously) if example process 1300 finds the following: a set component index command, set dependency index command, set strict order command, set parameters command, or override parameters command. This is referenced via a “yes” decision, such as at an ordering point operation 1318. Example process 1300 may then proceed to operation 1320, such as to join forked commands, for example, and process these commands in a specified order (e.g., one at a time, etc.), such as discussed above with reference to operation 1312.

As referenced at operation 1322, if an ordering point has not been reached, such as if no above-referenced commands are found, example process 1300 may continue “forking” or processing commands asynchronously, such as out of order and/or in parallel, for example, as further referenced generally via a back loop at 1324. If no more “forking” is appropriate, a command processing function that corresponds to a command ID for a current command may, for example, be executed, such as referenced at operation 1326. As further illustrated at 1328, example process 1300 may exit. In some instances, here, example process 1300 may also forward the last status code that occurred in a command sequence (e.g., at operation 1326, etc.), a status may be reaped by a join command. For example, as indicated above, a particular command that is processed in parallel may either succeed or fail. In some instances, this may not be picked up by an originating context, for example, until it reaps an exit status of the command. This may, for example, occur if it “joins” the command. At times, this may, for example, facilitate and/or support in-order processing of one or more sequences within a parallel processing context.

Thus, as discussed, a Strict Order parameter may facilitate and/or support parallel processing of some commands, for example, or reordering of some commands. To illustrate, in a particular implementation, to perform parallel processing, once a Strict Order parameter is set to False, an asynchronous process (e.g., process 1300, etc.) may “fork” each command until the Strict Order parameter is returned to True, for example, or a command sequence ends. Then, an asynchronous process may, for example, join all forked processes before continuing processing of commands. To perform out-of-order processing, a similar approach may be used, except an asynchronous process may, for example, consume all commands after a Strict Order parameter is set to False, then it may sort these commands into its preferred order, invoke them all, then continue processing (e.g., at operations 1208, 1210, 1212, etc. of FIG. 12, etc.).

Thus, referring back to FIG. 12, in an implementation, having processed one or more applicable commands asynchronously, example process 1200 may terminate, as referenced generally at 1214.

As indicated above, in some instances, one or more commands may be executed, such as subsequently, for example, in a duplicate copy of a current dependency, which may be facilitate and/or support more secure updates, updates within critical infrastructure, etc. Thus, attention is now drawn to FIG. 14, which is a flow diagram of an implementation of an example process 1400 that may be employed, in whole or in part, to facilitate and/or support one or more operations and/or techniques for infrastructure for securing and/or managing IoT-type devices, such as processing one or more dependencies. For example, as also indicated, in some instances, example process 1300 may be implemented, at least in part, in connection with operations 1008, 1010, and/or 1012 of FIG. 10, operations 1108, 1110, and/or 1112 of FIG. 11, operations 1208, 1210, and/or 1212 of FIG. 12, etc., such as in connection with executing one or more corresponding command sequences (e.g., Dependency Resolution, Image Fetch, Image Install, etc.). It should be noted that information acquired or produced, such as, for example, input signals, output signals, operations, results, etc. associated with example process 1400 may be represented via one or more digital signals. It should also be appreciated that even though one or more operations are illustrated or described concurrently or with respect to a certain progression, other progressions or concurrent operations may be employed. In addition, although the description below references particular aspects or features illustrated in certain other figures, one or more operations may be performed with other aspects or features.

Thus, example process 1400 may begin (e.g., process dependencies may be invoked) at operation 1402, for example, and may proceed to determine which sequence is executing in a current manifest, as referenced at operation 1404. Here, example process 1400 may access a current dependency index, for example, and may identify a currently executing dependency sequence, such as via an appropriate look-up operation. Subsequently, example process 1400 may load such a dependency into accessible memory (e.g., a buffer, etc.), for example, so that it may be able to access the dependency in a more effective and/or more efficient manner. At operations 1408 and 1410, respectively, current parameters may be copied to dependency parameters, for example, and a dependency common sequence may be executed, such as to update dependency common parameters, as also discussed above. With regard to operation 1412, a dependency sequence corresponding to (e.g., matching) the current sequence, such as determined above, may be executed. To illustrate, if an Image Fetch sequence was executing while a process dependency was invoked, for example, the Image Fetch sequence will be executed in that dependency. Claimed subject matter is not limited to a particular sequence, of course.

As indicated above, in some instances, it may be useful to provide a command sequence that may “soft-fail,” such as fail without terminating an update, for example. Here, a conditional processing may, for example, be used, in whole or in part. Thus, continuing now with FIG. 15, which is a flow diagram of an implementation of an example process 1500 that may be employed, in whole or in part, to facilitate and/or support one or more operations and/or techniques for infrastructure for securing and/or managing IoT-type devices, such as via implementing conditional processing. It should be noted that information acquired or produced, such as, for example, input signals, output signals, operations, results, etc. associated with example process 1500 may be represented via one or more digital signals. It should also be appreciated that even though one or more operations are illustrated or described concurrently or with respect to a certain progression, other progressions or concurrent operations may be employed. In addition, although the description below references particular aspects or features illustrated in certain other figures, one or more operations may be performed with other aspects or features.

Thus, example process 1500 may begin at operation 1502, for example, and may proceed to operations 1504 and 1506 so as to copy current parameters to subsequence parameters and run Subsequence so as to collect success or failure state, respectively. For example, a particular condition (e.g., a firmware version, etc.) may be tested using a subsequence to determine if this condition is success (e.g., a device is running the same firmware version, etc.) or failure (e.g., a device is running a different firmware version, etc.). At operation 1508, example process 1500 may check if an Optional Flag is set in these subsequence parameters. If no, as decided at operation 1510, example process 1500 may terminate (e.g., an update or sequence may abort, such as if firmware versions are not the same, etc.), as referenced at operation 1508, for example. If it is determined that an Optional Flag is set, however, example process 1500 may proceed to operation 1512 to determine if a failure state is a condition failure, such as via a Soft Failure aspect discussed above. If no, example process 1500 may terminate, for example, as referenced at 1518. If yes (e.g., condition failure is True, etc.), at operation 1516, a failure state may, for example, be replaced with a success state. For example, a success code of a command segment may be coerced to success even if a current sequence is aborted due to a condition failure. Subsequently, having replaced a failure state with success, example process 1500 may terminate at operation 1518.

Accordingly, as discussed herein, one or more operations and/or techniques for infrastructure for securing and/or managing IoT-type devices may provide benefits. For example, as was indicated, via one or more operations and/or techniques discussed herein, a more flexible behavior to constrained electronic devices may be provided, such as while allowing more powerful devices to use their full capabilities. In addition, a language specifies behaviors in a linearized form, such as without reverse branches, for example, and is extremely high level, such as comprising operations that a device may perform during update and/or secure boot of a firmware image. Also, conditional processing is supported, and/or parallel and out-of-order processing may, for example, be performed by sufficiently capable devices. By structuring a language this way, a manifest processor may become a simpler engine, such as utilizing a pull parser to interpret the manifest, for example. In addition, since a language is structured in a highly regular pattern, this may, for example, simplify a parser. As such, a device with minimal functionality may be capable of performing more complex updates with reduced overhead. In addition, conditional execution of commands may allow a simpler device to perform important decisions at validation-time, such as, for example, which differential update to download for a given current version, which hash to check based on an installation address, or the like.

Dependency handling is vastly simplified as well. For example, dependencies may function like subroutines of a language, and if a manifest has a dependency, it may invoke that dependency's commands and modify their behavior by setting one or more appropriate parameters, as was indicated. Also, because a number of parameters may come with security implications, dependencies also have a mechanism to reject modifications to parameters on a fine-grained level. Further, via one or more operations and/or techniques discussed, a more robust permissions system may be developed. For example, a device may use a simple ACL, such as comprising a table of Identities and Component Identifier permissions, to ensure that only manifests authenticated by an appropriate identity have access to define a component. In addition, as discussed above, capability reporting may be simplified. For example, a device may report one or more Commands and/or Parameters that it supports. This may be useful for a manifest author to create a manifest that a device may accept.

Further, because a behavioral description is more precise, and a machine definition upon which it relies is simpler, it may, for example, be augmented with proof that effects of an update fall within a specified policy, such as similarly to a Proof Carrying Code. By combining this capability with formal verification of a document processor, it may, for example, be possible to prove a result of a firmware update, such as prior to application, either on a device or on an intermediate system, or any combination thereof. In some instances, this proof may, for example, be discarded before distribution to constrained devices, thus, creating no additional overhead. Also, a simplicity of design in a device due, at least in part, to these benefits may allow a highly constrained platform to use advanced update capabilities. Of course, such a description of certain aspects of electronic authentication infrastructure and its benefits is merely an example, and claimed subject matter is not so limited.

In the context of the present disclosure, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other electrical conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, is also used to mean that two or more tangible components and/or the like are not necessarily tangibly in direct physical contact, but are able to co-operate, liaise, and/or interact, such as, for example, by being “optically coupled.” Likewise, the term “coupled” may be understood to mean indirectly connected in an appropriate context. It is further noted, in the context of the present disclosure, the term physical if used in relation to memory, such as memory components or memory states, as examples, necessarily implies that memory, such memory components and/or memory states, continuing with the example, is tangible.

Additionally, in the present disclosure, in a particular context of usage, such as a situation in which tangible components (and/or similarly, tangible materials) are being discussed, a distinction exists between being “on” and being “over.” As an example, deposition of a substance “on” a substrate refers to a deposition involving direct physical and tangible contact without an intermediary, such as an intermediary substance (e.g., an intermediary substance formed during an intervening process operation), between the substance deposited and the substrate in this latter example; nonetheless, deposition “over” a substrate, while understood to potentially include deposition “on” a substrate (since being “on” may also accurately be described as being “over”), is understood to include a situation in which one or more intermediaries, such as one or more intermediary substances, are present between the substance deposited and the substrate so that the substance deposited is not necessarily in direct physical and tangible contact with the substrate.

A similar distinction is made in an appropriate particular context of usage, such as in which tangible materials and/or tangible components are discussed, between being “beneath” and being “under.” While “beneath,” in such a particular context of usage, is intended to necessarily imply physical and tangible contact (similar to “on,” as just described), “under” potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under.”

It is likewise appreciated that terms such as “over” and “under” are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes a flip chip, as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present disclosure, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Furthermore, the terms “first,” “second” “third,” and the like are used to distinguish different aspects, such as different components, as one example, rather than supplying a numerical limit or suggesting a particular order, unless expressly indicated otherwise. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, to be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques, even if those reasonable alternative techniques do not provide identical values, identical measurements or identical results, unless otherwise expressly indicated.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be predominantly present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present disclosure merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices, one or more server devices and/or one or more peer-to-peer devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device, a client device and/or a peer-to-peer device, as well as other types of devices, including between wired and/or wireless devices coupled via a wired and/or wireless network, for example.

An example of a distributed computing system comprises the so-called Hadoop distributed computing system, which employs a map-reduce type of architecture. In the context of the present disclosure, the terms map-reduce architecture and/or similar terms are intended to refer to a distributed computing system implementation and/or embodiment for processing and/or for generating larger sets of signal samples employing map and/or reduce operations for a parallel, distributed process performed over a network of devices. A map operation and/or similar terms refer to processing of signals (e.g., signal samples) to generate one or more key-value pairs and to distribute the one or more pairs to one or more devices of the system (e.g., network). A reduce operation and/or similar terms refer to processing of signals (e.g., signal samples) via a summary operation (e.g., such as counting the number of students in a queue, yielding name frequencies, etc.). A system may employ such an architecture, such as by marshaling distributed server devices, executing various tasks in parallel, and/or managing communications, such as signal transfers, between various parts of the system (e.g., network), in an embodiment. As mentioned, one non-limiting, but well-known, example comprises the Hadoop distributed computing system. It refers to an open source implementation and/or embodiment of a map-reduce type architecture (available from the Apache Software Foundation, 1901 Munsey Drive, Forrest Hill, Md., 21050-2747), but may include other aspects, such as the Hadoop distributed file system (HDFS) (available from the Apache Software Foundation, 1901 Munsey Drive, Forrest Hill, Md., 21050-2747). In general, therefore, “Hadoop” and/or similar terms (e.g., “Hadoop-type,” etc.) refer to an implementation and/or embodiment of a scheduler for executing larger processing jobs using a map-reduce architecture over a distributed system. Furthermore, in the context of the present disclosure, use of the term “Hadoop” is intended to include versions, presently known and/or to be later developed.

In the context of the present disclosure, the term “network device” refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in a non-transitory memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

In the context of the present disclosure, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present disclosure, the term “transparent,” if used with respect to particular communicating devices of a network, refers to the devices communicating via the network in which the devices are able to communicate via one or more intermediate devices, such as of one or more intermediate nodes, but without the communicating devices necessarily specifying the one or more intermediate nodes and/or the one or more intermediate devices of the one or more intermediate nodes. Thus, a network may include the one or more intermediate nodes and/or the one or more intermediate devices of the one or more intermediate nodes in communications and the network may engage in communications via the one or more intermediate nodes and/or the one or more intermediate devices of the one or more intermediate nodes, but the network may operate as if such intermediate nodes and/or intermediate devices are not necessarily involved in communications between the particular communicating devices. For example, a router may provide a link and/or connection between otherwise separate and/or independent LANs.

In the context of the present disclosure, a “private network” refers to a particular, limited set of devices, such as network devices and/or computing devices, able to communicate with other devices, such as network devices and/or computing devices, in the particular, limited set, such as via signal packet and/or signal frame communications, for example, without a need for re-routing and/or redirecting signal communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet. Although signal packet and/or frame communications (e.g. signal communications) may employ intermediate devices of intermediate nodes to exchange signal packets and/or signal frames, those intermediate devices may not necessarily be included in the private network by not being a source or designated destination for one or more signal packets and/or signal frames, for example. It is understood in the context of the present disclosure that a private network may direct outgoing signal communications to devices not in the private network, but devices outside the private network may not necessarily be able to direct inbound signal communications to devices included in the private network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long haul networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a self-sustaining facility accessible to potentially billions of people or more worldwide. Also, in an embodiment, and as mentioned above, the terms “WWW” and/or “Web” refer to a part of the Internet that complies with the Hypertext Transfer Protocol. The Internet and/or the Web, therefore, in the context of the present disclosure, may comprise a service that organizes stored digital content, such as, for example, text, images, video, etc., through the use of hypermedia, for example. It is noted that a network, such as the Internet and/or Web, may be employed to store electronic files and/or electronic documents.

The term “electronic file” and/or the term “electronic document” or the like are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present disclosure, the term “Web site” and/or similar terms refer to Web pages that are associated electronically to form a particular collection thereof. Also, in the context of the present disclosure, “Web page” and/or similar terms refer to an electronic file and/or an electronic document accessible via a network, including by specifying a uniform resource locator (URL) for accessibility via the Web, in an example embodiment. As alluded to above, in one or more embodiments, a Web page may comprise digital content coded (e.g., via computer instructions) using one or more languages, such as, for example, markup languages, including HTML and/or XML, although claimed subject matter is not limited in scope in this respect. Also, in one or more embodiments, application developers may write code (e.g., computer instructions) in the form of JavaScript (or other programming languages), for example, executable by a computing device to provide digital content to populate an electronic document and/or an electronic file in an appropriate format, such as for use in a particular application, for example. Use of the term “JavaScript” and/or similar terms intended to refer to one or more particular programming languages are intended to refer to any version of the one or more programming languages identified, now known and/or to be later developed. Thus, JavaScript is merely an example programming language. As was mentioned, claimed subject matter is not intended to be limited to examples and/or illustrations.

As was indicated, in the context of the present disclosure, the terms “entry,” “electronic entry,” “document,” “electronic document,” “content”, “digital content,” “item,” “object,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present disclosure, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present disclosure, a component is physical, but is not necessarily tangible. As an example, components with reference to an electronic document and/or electronic file, in one or more embodiments, may comprise text, for example, in the form of physical signals and/or physical states (e.g., capable of being physically displayed and/or maintained as a memory state in a tangible memory). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed and/or maintained as a memory state in a tangible memory). In an embodiment, digital content may comprise, for example, text, images, audio, video, haptic content and/or other types of electronic documents and/or electronic files, including portions thereof, for example.

Also, in the context of the present disclosure, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this disclosure, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present disclosure, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present disclosure, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

In the context of the particular disclosure, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present disclosure, the term “between” and/or similar terms are understood to include “among” if appropriate for the particular usage and vice-versa. Likewise, in the context of the present disclosure, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

A network and/or sub-network, in an embodiment, may communicate via signal packets and/or signal frames, such via participating digital devices and may be substantially compliant and/or substantially compatible with, but is not limited to, now known and/or to be developed, versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A network and/or sub-network may employ, for example, a version, now known and/or later to be developed, of the following: TCP/IP, UDP, DECnet, NetBEUI, IPX, AppleTalk and/or the like. Versions of the Internet Protocol (IP) may include IPv4, IPv6, and/or other later to be developed versions.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, or 4th generation (2G, 3G, or 4G) cellular technology and/or the like, whether currently known and/or to be later developed. Network access technologies may enable wide area coverage for devices, such as computing devices and/or network devices, with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra-wideband (UWB), IEEE 802.11 (including, but not limited to, IEEE 802.11b/g/n), and/or the like. A wireless network may include virtually any type of now known and/or to be developed wireless communication mechanism and/or wireless communications protocol by which signals may be communicated between devices, between networks, within a network, and/or the like, including the foregoing, of course.

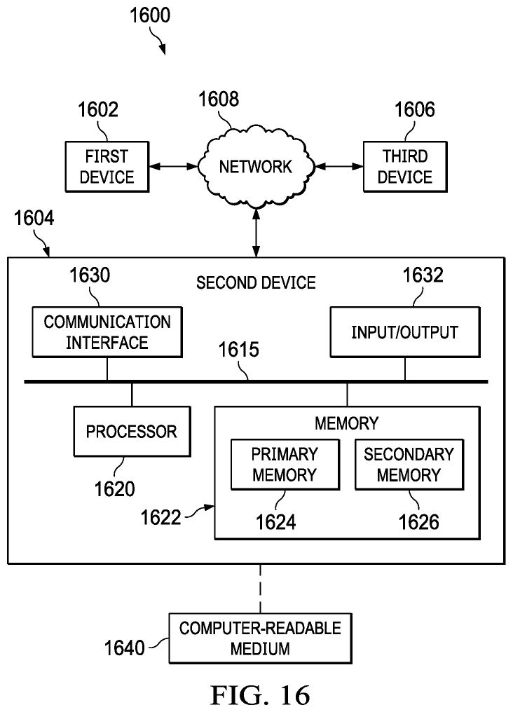

In one example embodiment, as shown in FIG. 16, a system embodiment may comprise a local network (e.g., a second device 1604 and a computer-readable medium 1640) and/or another type of network, such as a computing and/or communications network. For purposes of illustration, therefore, FIG. 16 shows an embodiment 1600 of a system that may be employed to implement either type or both types of networks. Network 1608 may comprise one or more network connections, links, processes, services, applications, and/or resources to facilitate and/or support communications, such as an exchange of communication signals, for example, between a computing device, such as 1602, and another computing device, such as 1606, which may, for example, comprise one or more client computing devices and/or one or more server computing device. By way of example, but not limitation, network 1608 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 16 may comprise features, for example, of a client computing device and/or a server computing device, in an embodiment. It is further noted that the term computing device, in general, whether employed as a client and/or as a server, or otherwise, refers at least to a processor and a memory connected by a communication bus. Likewise, in the context of the present disclosure at least, this is understood to refer to sufficient structure within the meaning of 35 § USC 112 (f) so that it is specifically intended that 35 § USC 112 (f) not be implicated by use of the term “computing device” and/or similar terms; however, if it is determined, for some reason not immediately apparent, that the foregoing understanding cannot stand and that 35 § USC 112 (f) therefore, necessarily is implicated by the use of the term “computing device” and/or similar terms, then, it is intended, pursuant to that statutory section, that corresponding structure, material and/or acts for performing one or more functions be understood and be interpreted to be described at least in FIGS. 1 and 16 of the present disclosure.

Referring now to FIG. 16, in an embodiment, first and third devices 1602 and 1606 may be capable of rendering a graphical user interface (GUI) for a network device and/or a computing device, for example, so that a user-operator may engage in system use. Device 1604 may potentially serve a similar function in this illustration. Likewise, in FIG. 16, computing device 1602 (‘first device’ in figure) may interface with computing device 1604 (‘second device’ in figure), which may, for example, also comprise features of a client computing device and/or a server computing device, in an embodiment. Processor (e.g., processing device) 1620 and memory 1622, which may comprise primary memory 1624 and secondary memory 1626, may communicate by way of a communication bus 1615, for example. The term “computing device,” in the context of the present disclosure, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present disclosure, may comprise hardware, software, firmware, or any combination thereof (other than software per se). Computing device 1604, as depicted in FIG. 16, is merely one example, and claimed subject matter is not limited in scope to this particular example.

For one or more embodiments, a computing device may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). A computing device and/or a networking device may also have a subscriber identity module (SIM) card, which, for example, may comprise a detachable or embedded smart card that is able to store subscription content of a user, and/or is also able to store a contact list. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of e-mail, short message service (SMS), and/or multimedia message service (MMS), including via a network, such as a social network, formed at least in part by a portion of a computing and/or communications network, including, but not limited to, Facebook, LinkedIn, Twitter, Flickr, and/or Google+, to provide only a few examples. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In FIG. 16, computing device 1602 may provide one or more sources of executable computer instructions in the form physical states and/or signals (e.g., stored in memory states), for example. Computing device 1602 may communicate with computing device 1604 by way of a network connection, such as via network 1608, for example. As previously mentioned, a connection, while physical, may not necessarily be tangible. Although computing device 1604 of FIG. 16 shows various tangible, physical components, claimed subject matter is not limited to computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 1622 may comprise any non-transitory storage mechanism. Memory 1622 may comprise, for example, primary memory 1624 and secondary memory 1626, additional memory circuits, mechanisms, or combinations thereof may be used. Memory 1622 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 1622 may be utilized to store a program of executable computer instructions. For example, processor 1620 may fetch executable instructions from memory and proceed to execute the fetched instructions. Memory 1622 may also comprise a memory controller for accessing device readable-medium 1640 that may carry and/or make accessible digital content, which may include code, and/or instructions, for example, executable by processor 1620 and/or some other device, such as a controller, as one example, capable of executing computer instructions, for example. Under direction of processor 1620, a non-transitory memory, such as memory cells storing physical states (e.g., memory states), comprising, for example, a program of executable computer instructions, may be executed by processor 1620 and able to generate signals to be communicated via a network, for example, as previously described. Generated signals may also be stored in memory, also previously suggested.

Memory 1622 may store electronic files and/or electronic documents, such as relating to one or more users, and may also comprise a device-readable medium that may carry and/or make accessible content, including code and/or instructions, for example, executable by processor 1620 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present disclosure, and generally, is considered to be a self-consistent sequence of operations and/or similar signal processing leading to a desired result. In the context of the present disclosure, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular disclosure, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 16, processor 1620 may comprise one or more circuits, such as digital circuits, to perform at least a portion of a computing procedure and/or process. By way of example, but not limitation, processor 1620 may comprise one or more processors, such as controllers, microprocessors, microcontrollers, application specific integrated circuits, digital signal processors, programmable logic devices, field programmable gate arrays, the like, or any combination thereof. In various implementations and/or embodiments, processor 1620 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 16 also illustrates device 1604 as including a component 1632 operable with input/output devices, for example, so that signals and/or states may be appropriately communicated between devices, such as device 1604 and an input device and/or device 1604 and an output device. A user may make use of an input device, such as a computer mouse, stylus, track ball, keyboard, and/or any other similar device capable of receiving user actions and/or motions as input signals. Likewise, a user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method comprising:
electronically specifying a behavior of an electronic device on a network for updating a target file stored on said electronic device, said behavior being specified in a linearized form via a language comprising a highly regular pattern specifying at least one command sequence of a dependent operation governed by a precondition sequence defining a result of a previous command sequence.

2. The method of claim 1, wherein said updating said target file is implemented via at least one of the following: a strict order processing defined via said highly regular pattern; an out-of-order processing defined via said highly regular pattern; a parallel processing defined via said highly regular pattern; or any combination thereof.

3. The method of claim 1, wherein said behavior is specified via a behavioral electronic document.

4. The method of claim 3, wherein said behavioral electronic document comprises a behavioral manifest.

5. The method of claim 1, wherein said highly regular pattern defines a plurality of behaviors to be supported by said electronic device.

6. The method of claim 5, wherein said plurality of behaviors are defined so as to allow said electronic device to implement said updating said target file according to an update capability of said electronic device.

7. The method of claim 1, wherein said updating said target file is implemented via at least one of the following: a bootloader; a simple updater; an advanced updater; or any combination thereof.

8. The method of claim 1, wherein said behavior specified in said linearized form comprises a behavior encoded via said highly regular pattern without reverse branches.

9. The method of claim 1, wherein said behavior comprises at least one of the following: a common behavior; a dependency resolution behavior; an image acquisition behavior; an image application behavior; a system validation behavior; an image loading behavior; an image invocation behavior; or any combinations thereof.

10. The method of claim 1, wherein said highly regular pattern further comprises one or more directives and one or more conditions for implementing said updating said target file.

11. The method of claim 1, wherein said updating said target file further comprises:
executing a common sequence in a dependency identified while said at least one command sequence is being invoked; and
executing said at least one command sequence in a duplicate copy of said dependency.

12. The method of claim 1, wherein said updating said target file includes a secure boot operation.

13. The method of claim 1, wherein said updating said target file includes electronically forwarding execution of said at least one command sequence to a designated component of said electronic device.

14. The method of claim 1, wherein said target file comprises at least one of the following: a firmware image; a component; a document storage; a computer file; or any combination thereof.

15. The method of claim 1, wherein said electronic device comprises an Internet-of-Things (IoT)-type device.

16. The method of claim 1, wherein said network comprises at least one of the following: a wireless communications network; a wired communications network; an optical communications network; or any combination thereof.

17. The method of claim 1, wherein said behavior comprises a conditional behavior specified via one or more subsequences so as to allow said at least one command to be flagged as optional.

18. An apparatus comprising:
a communication interface to communicate with a network and one or more processors coupled to a memory and to the communication interface, the communication interface and the one or more processors to:
electronically specify a behavior of an electronic device on said network to implement an update of a target file to be stored on said electronic device, said behavior to be specified in a linearized form via a language to comprise a highly regular pattern to specify at least one command sequence of a dependent operation to be governed by a precondition sequence that defines a result of a previous command sequence.

19. The apparatus of claim 18, wherein said update of said target file to be implemented via at least one of the following: a particular order process defined via said highly regular pattern; an out-of-order process defined via said highly regular pattern; a parallel process defined via said highly regular pattern; or any combination thereof.

20. A non-transitory storage medium having instructions executable by a processor to:
electronically specify a behavior of an electronic device on a network to implement an update of a target file to be stored on said electronic device, said behavior to be specified in a linearized form via a language to comprise a highly regular pattern that has at least one command sequence of a dependent operation to be governed by a precondition sequence that defines a result of a previous command sequence.

21. The non-transitory storage medium of claim 20, wherein said update of said target file to be implemented via at least one of the following: a particular order process defined via said highly regular pattern; an out-of-order process defined via said highly regular pattern; a parallel process defined via said highly regular pattern; or any combination thereof.
